(19) United States
(12) Patent Application Publication
(10) Pub. No.: US 2025/0190783 A1
(43) Pub. Date: Jun. 12, 2025

(54) METHODS AND APPARATUS UTILIZING UNCERTAINTY

(71) Applicant: JPMORGAN CHASE BANK, N.A., New York, NY (US)

(72) Inventors: Yousef El-Laham, Dallas, TX (US); Niccolo Dalmasso, Long Island City, NY (US); Elizabeth Fons, London (GB); Svitlana Vyetrenko, Berkeley, CA (US)

(73) Assignee: JPMORGAN CHASE BANK, N.A., New York, NY (US)

(21) Appl. No.: 18/535,591

(22) Filed: Dec. 11, 2023

(51) Int. Cl. G06N 3/08

(52) U.S. Cl. CPC G06N 3/08

(57) ABSTRACT

Aspects of the subject disclosure may include, for example, identifying a number of mixture components of a mixture ensemble of an artificial neural network. The neural network is trained according to a set of features and a corresponding set of output values associated with the set of features. A set of mixture weights and a set of mixture parameters of the mixture ensemble are determined, and a set of posterior probabilities is calculated according to the sets of mixture weights and mixture parameters. The sets of mixture weights and mixture parameters are revised according to an optimization process to obtain a revised set of mixture weights determined according to a sum of the set of posterior probabilities and a revised set of mixture parameters determined according to a solution of a numerical optimization. Other embodiments are disclosed.

### FIELD OF THE DISCLOSURE

The subject disclosure relates to methods and apparatus utilizing uncertainty.

### BACKGROUND

Uncertainty quantification plays a key role in the development and deployment of machine learning systems, especially in applications where user safety and risk assessment are of paramount importance. While deep learning (DL) has cemented its superiority in terms of raw predictive performance for a variety of applications, the principled incorporation of uncertainty quantification in DL models remains an open challenge.

Uncertainty in machine learning models is derived from two different sources: aleatoric uncertainty and epistemic uncertainty. Aleatoric uncertainty derives from measurement process of the data, while epistemic uncertainty derives from the uncertainty in the parameters of the machine learning model. A variety of approaches have been proposed to quantify both types of uncertainty in DL models from both a Bayesian and frequentist perspective.

In some instances, a probabilistic DL may be applied to exploit an inherent stochasticity in learning to quantify predictive uncertainty. Examples include techniques such as probabilistic backpropagation, Monte Carlo dropout (MCD), Monte Carlo batch normalization, deep ensembles (DEs) among others. MCD and DEs have emerged as state-of-the-art solutions for quantifying uncertainty in DL models due to their simplicity and effectiveness. MCD utilizes the inherent stochasticity of dropout, e.g., random masking of neural network weights, to form an ensemble-based approximation of the predictive distribution through multiple stochastic forward passes of the model to account for epistemic uncertainty.

### BRIEF DESCRIPTION OF THE DRAWINGS

Reference will now be made to the accompanying drawings, which are not necessarily drawn to scale, and wherein:

FIG. 1A is a block diagram illustrating an example of a machine learning model.

FIG. 1B is a block diagram illustrating an example of an uncertainty quantification machine learning model.

FIG. 2A is a block diagram illustrating an example, non-limiting embodiment of deep mixture ensemble model in accordance with various aspects described herein.

FIG. 2B is a block diagram illustrating an example, non-limiting embodiment of an uncertainty quantification model in accordance with various aspects described herein.

FIG. 2C is a block diagram illustrating an example, non-limiting embodiment of another uncertainty quantification model in accordance with various aspects described herein.

FIG. 3A is a block diagram illustrating an example, non-limiting embodiment of a machine learning system in accordance with various aspects described herein.

FIG. 3B a block diagram illustrating another example, non-limiting embodiment of a machine learning system in accordance with various aspects described herein.

FIG. 4A is a block diagram illustrating another example, non-limiting embodiment of deep mixture ensemble model in accordance with various aspects described herein.

FIG. 4B is a block diagram illustrating yet another example, non-limiting embodiment of deep mixture ensemble model in accordance with various aspects described herein.

FIG. 5 is a deep-ensemble performance graph illustrating an example performance of an example, non-limiting embodiment of a deep ensemble model in accordance with various aspects described herein.

FIG. 6A is a deep-ensemble (DE) performance graph providing example predictive distribution plots for a bimodal Gaussian toy regression example in accordance with various aspects described herein.

FIG. 6B is a deep Gaussian mixture ensemble (DGME) performance graph providing another example predictive distribution plots for a bimodal Gaussian toy regression example in accordance with various aspects described herein.

FIG. 7 depicts an illustrative embodiment of a deep-Gaussian-mixture ensemble process in accordance with various aspects described herein.

FIG. 8 is a block diagram of an example, non-limiting embodiment of a computing environment in accordance with various aspects described herein.

FIG. 9 is a graph of results on a toy regression task with Gaussian noise for different numbers of EM rounds.

FIG. 10 provides a graph of results on a toy regression task with Gaussian noise.

FIG. 11 provides a graph of an effect of a number of mixtures on a learned kurtosis of the predictive distribution under heavy-tailed noise.

FIG. 12 provides a graph of an effect of the number of mixture components on the learned predictive distribution under bimodal noise.

FIG. 13 provides a graph of performance on a toy regression task with Gaussian noise of DGMEs compared with performance of other state-of-the-art techniques.

### DETAILED DESCRIPTION

The subject disclosure describes, among other things, illustrative embodiments for uncertainty quantification of deep neural networks based on Gaussian mixture ensembles. Other embodiments are described in the subject disclosure.

One or more aspects of the subject disclosure include a process that includes obtaining, by a processing system including a processor, a set of n training samples that includes a set of n features and a corresponding set of n output values associated with the set of features. The process further includes determining, by the processing system, a number, k, of mixture components and obtaining, by the processing system, a set of k mixture weights and a set of k mixture parameters. According to the process, a set of posterior probabilities is updated by the processing system, according to the set of k mixture weights and the set of k mixture parameters for each k and n. The set of mixture weights and the set of mixture parameters are updated, by the processing system, for each k according to an optimization process to obtain an updated set of k mixture weights and an updated set of k mixture parameters. The updated set of k mixture weights are determined according to a sum of the set of posterior probabilities, and wherein the updated set of k mixture parameters are determined according to a stochastic optimization model.

One or more aspects of the subject disclosure include a device having a processing system including a processor and a memory that stores executable instructions. The executable instructions, when executed by the processing system, facilitate performance of operations that include receiving a set of training samples comprising a set of features and a corresponding set of output values associated with the set of features, identifying a number of mixture components, and obtaining a set of mixture weights and a set of mixture parameters. A set of posterior probabilities is received, wherein the set of posterior probabilities is according to the set of mixture weights and the set of mixture parameters. The set of mixture weights and the set of mixture parameters are revised according to a process to obtain an updated set of mixture weights determined according to a sum of the set of posterior probabilities and an updated set of mixture parameters determined according to a numerical model.

One or more aspects of the subject disclosure include a non-transitory, machine-readable medium, including executable instructions that, when executed by a processing system including a processor, facilitate performance of operations. The operations include identifying a number of mixture components of a mixture ensemble of an artificial neural network trained according to a set of features and a corresponding set of output values associated with the set of features. Sets are determined of mixture weights and mixture parameters of the mixture ensemble; a set of posterior probabilities is calculated according to the set of mixture weights and the set of mixture parameters. The sets of mixture weights mixture parameters are revised to obtain a revised set of mixture weights determined according to a sum of the set of posterior probabilities and a revised set of mixture parameters determined according to a numerical model.

This work introduces a novel probabilistic deep learning technique called deep Gaussian mixture ensembles (DGMEs), which enables accurate quantification of both epistemic and aleatoric uncertainty. By assuming the data generating process follows that of a Gaussian mixture, DGMEs are capable of approximating complex probability distributions, such as heavy-tailed or multimodal distributions. Contributions of the subject disclosure include, without limitation, the derivation of an expectation-maximization (EM) algorithm used for learning the model parameters, which results in an upper-bound on the log-likelihood of training data over that of standard deep ensembles. Additionally, the proposed EM training procedure allows for learning of mixture weights, which is not commonly done in ensembles. Experimental results demonstrate that DGMEs outperform state-of-the-art uncertainty quantifying deep learning models in handling complex predictive densities.

Disclosed herein are novel probabilistic DL techniques adapted to jointly quantify epistemic and aleatoric uncertainty of a machine learning model. The probabilistic DL techniques include, without limitation, deep-Gaussian-mixture ensembles (DGMEs) that are configured to train a weighted DE neural network, e.g., using an expectation maximization algorithm.

In at least some embodiments, the disclosed probabilistic DL techniques, e.g., DGMEs, refine, e.g., optimize, a joint data likelihood directly, unlike DE neural networks that target a lower bound of a data likelihood. Beneficially, the disclosed probabilistic DL techniques, e.g., DGMEs, generally achieve a superior loss to DE techniques. For example, the disclosed probabilistic DL techniques, e.g., DGMEs, have been observed to be more expressive than standard probabilistic DL approaches, for example, capturing heavy-tailedness, multimodality and/or a combination of both heavy-tailedness, multimodality.

It is understood that in many instances, standard DL models are unable to properly quantify predictive uncertainty. For example, one common challenge for deep learning models is detecting out-of-distribution (OOD) inputs. It is often the case that OOD inputs lead a DL model into making erroneous predictions. Without uncertainty quantification, one cannot reason about whether an input is OOD and this can be catastrophic in applications such as machine-assisted medical decision making or self-driving vehicles. Moreover, uncertainty quantification can also be used as a means to select samples to label in active learning scenarios and/or for enabling exploration in reinforcement learning algorithms.

At least some probabilistic DL techniques apply a Bayesian paradigm, in which a goal would be to infer a posterior predictive density of a target variable given input features and training data, which encodes both types of uncertainty. Unfortunately, exact Bayesian inference algorithms cannot scale to the parameter space of modern DL architectures, and one often must resort to mini-batching or forming a rough parametric approximation of the posterior distribution of the parameters, such as the Laplace approximation or stochastic variational inference. At least one drawback of a parametric approach is an inability to express more complex, e.g., heavy-tailed or multimodal, predictive distributions. As an example, approximations such as mean-field variational inference form a Gaussian predictive distribution that tends to underestimate the true uncertainty of more complex models.

At least some probabilistic DL approach may be applied to account for epistemic uncertainty. Estimation of the aleatoric uncertainty, in such applications, may be handled as a post-processing step, e.g., under an assumption that the underlying data noise is homoscedastic. In some probabilistic DL approaches, DEs may independently train a small ensemble of dual-output neural networks, in which the outputs characterize the mean and variance of a predictive distribution, e.g., a normal or Gaussian distribution. It is envisioned that each network in an ensemble may be independently trained to maximize a likelihood of the data, e.g., under the heteroscedastic Gaussian assumption. At test time, the networks may be linearly combined into a single Gaussian approximation of the predictive distribution. Unfortunately, neither MCD nor DEs are adequate solutions for modeling more complex data distributions, e.g., heavy-tailed or multimodal distributions.

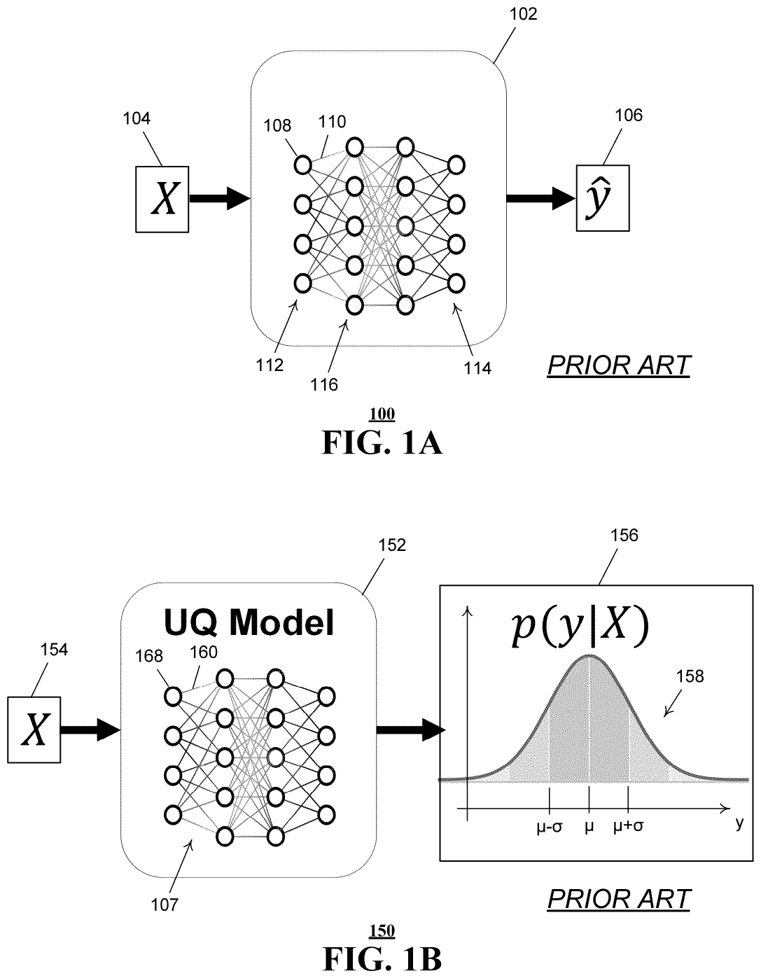

FIG. 1A is a block diagram illustrating an example of a machine learning model 100. According to the illustrative example, the machine learning model 100 includes an artificial neural network 102 that receives input feature(s) 104 and, internally process the input feature(s) 104 and provides one or more output label(s) 106 responsive to the input feature(s) 104 and the internal processing. The machine learning model 100, e.g., the artificial neural network 102, may be trained to predict an output y, given a corresponding input value, or group of values, e.g., according to an input vector x.

In more detail, the artificial neural network 102 includes artificial neurons or nodes 108. Pairs of nodes 108 are interconnected by an artificial synapse, also referred to as respective connection edges 110, to form a network. The interconnected nodes 108 receive inputs from the input feature(s) 104 and/or from other interconnected nodes 108. Weights may be applied according to the connection edges 110 and a node may combine, e.g., sum the weighted combination of inputs from other node(s) 108. In at least some embodiments, a bias term may be applied to the sum. Together, the weights and bias terms may be referred to as parameters of the neural network. A node 108 may apply a function, sometimes referred to as an activation function, upon the biased, weighted sum of inputs to obtain an output value. The output value may be passed along to other nodes 108, e.g., according to a network configuration, e.g., being weighted and biased according to the network parameters, and/or passed directly to the output label(s) 106.

The example artificial neural network 102 includes an initial layer of nodes, referred to as an input layer 112. Nodes 108 of the input layer 112 receive input feature(s) 104, apply an activation function and pass along output values to other interconnected nodes according to weights of applicable connection edges 110. The example artificial neural network 102 also includes a final layer of nodes, referred to as an output layer 114. Nodes 108 of the output layer 114 obtain their weighted and biased inputs from interconnected nodes 108, apply their respective activation functions and pass along output values according to the output label(s) 106. It is understood that different layers 112, 116, 114 may perform similar and/or different transformations upon their respective inputs.

In particular, the example neural network 102 includes one or more, so called, hidden layers 116. These hidden layers 116 are not directly exposed to either the input feature(s) 104 or the output label(s) 106. Rather, nodes 108 of the hidden layers 116 are interconnected to other nodes 108 of the artificial neural network 102, e.g., performing as described. An artificial neural network 102 that includes hidden layers 116 may be referred to as a deep neural network (DNN).

The example artificial neural network 102 may also be referred to as a feed-forward type of artificial neural network 102. According to feed-forward networks, information moves only from the input layer 112, directly through any hidden layers 116, to the output layer 114, without any cycles and/or loops. It is understood that, without limitation, other artificial neural networks, including DNNs may utilize other configurations that may employ cycles and/or loops.

FIG. 1B is a block diagram illustrating an example of an uncertainty quantification (UQ) machine learning model 150. According to the illustrative example, the UQ machine learning model 150 includes a UQ artificial neural network 152 that receives one or more input feature(s) 154 and, internally process the input feature(s) 154 and provides one or more output labels 156 responsive to the input feature(s) 154 and the internal processing. The UQ machine learning model 150, e.g., the UQ artificial neural network 152, may be trained to predict output labels 156, y, given a corresponding input feature(s) 154, x. The example UQ artificial neural network 152 also includes an arrangement of nodes 168 and edges 160 arranged in layers as a DNN 107.

In contrast to the previous example machine learning model 100 (FIG. 1A), however, the output labels 156 may be used to provide and/or otherwise obtain an output distribution 158. According to the illustrative example, the output distribution 158 is described according to a probability density function that identifies a probability or likelihood according to an output value y. In at least some embodiments, the UQ artificial neural network 152 may be reconfigured with different parameters, e.g., weights and/or biases, to obtain different output values y for repeated application of the input value x, the differences resulting from different parameters. The output values may be evaluated to yield a distribution.

The example output distribution 158 is a normal distribution, centered about a mean value μ, and having a symmetrical spread according to a standard deviation σ. In application, the UQ artificial neural network 152 may provide an output value y that may be determined according to the output distribution 158 to evaluate whether the model output y is reliable, e.g., having a relatively high value, or less reliable, e.g., being located in one of the tails of the output distribution 158. It is envisioned that in at least some applications, the output labels 156 may include parameters that determine the output distribution, e.g., one output node providing a mean value and another output node providing a standard deviation or variance.

Some examples of related topics include mixture density networks, Monte Carlo dropout, deep ensembles, and neural expectation maximization. Mixture density networks (MDNs) use a deep neural network to simultaneously learn the means, variances and mixture weights of a Gaussian mixture model. MDNs have been successfully used in many machine learning applications, such as computer vision, speech synthesis, probabilistic forecasting, astronomy, chemistry and epidemiology, among others. While MDNs are closely related to deep Gaussian mixture ensembles (DGMEs) in terms of uncertainty quantification, they are not an ensemble technique per se, as the epistemic and aleatoric uncertainty cannot be disentangled in MDNs. Moreover, without an ensemble structure, the MDNs cannot easily be trained in a distributed setting, whereas the training of DGMEs can trivially be parallelized.

Application of MCD approaches exploit stochasticity of dropout training to quantify epistemic uncertainty in DL models. At test time, stochastic forward passes through a DL model with dropout produce “approximate” samples from the underlying posterior predictive distribution, which are typically summarized using first order and second-order moments, e.g., mean and variance of the samples. Aleatoric uncertainty is accounted for in a post-processing step, whereby an optimal homoscedastic variance that maximizes an evidence lower-bound may be obtained via cross-validation. MCD's popularity can be attributed to its simple implementation, as no changes to the standard DL training procedure are required. While MCD may yield favorable results in additive Gaussian settings, the method is less effective when dealing with more complex data generating processes, e.g., heavy-tailed and/or multimodal predictive densities. In at least some of the disclosed embodiments, MCD may be incorporated, e.g., into a training procedure to account for epistemic uncertainty.

Turning next to DEs, they may be utilized to quantify both aleatoric and epistemic uncertainty, e.g., by building an ensemble of independently trained models under different neural network weight initializations. Combined with adversarial training, DEs achieve competitive or better performance than MCD in most settings in terms of calibration of predictive uncertainty and in terms of reasoning about out-of-distribution (OOD) inputs. OOD inputs may include input values beyond the bounds of training and/or test inputs that may have been used during a training process. Arguably, DEs may be interpreted as a Bayesian approach, in which learned weights of each ensemble member correspond to a sample from a posterior distribution of the network weights. It can be appreciated that a DE approach may include variations, such as deep-split ensembles and/or hybrid training approaches that combine DEs with the Laplace approximation. At least one important distinction between DEs and DGMEs is that each sample in DEs is treated as an i.i.d. sample from a Gaussian distribution, whereas DGMEs assume that data are distributed according to a Gaussian mixture. Gaussian mixtures allow DGMEs to learn more complex data generating processes.

Neural expectation maximization (EM) refers to a differentiable clustering technique that combines principles of an EM algorithm with neural networks for representation learning, particularly in the field of computer vision for perceptual grouping tasks. A neural EM approach allows for a grouping the individual entities, e.g., pixels, of a given input, e.g., an image, that belong to the same object. To do this, a finite mixture model may be used to construct a latent representation of each image, in which each mixture component represents a distinct object. A neural network may then be used to transform parameters of that mixture model into pixel-wise distributions over the image, which supports a reasoning as to which object each pixel in the image belongs to. While neural EM combines the ideas of EM with deep learning, it should be appreciated that this differs from the DGME techniques disclosed herein, which focuses on an accurate quantification of predictive uncertainty in a supervised learning setting.

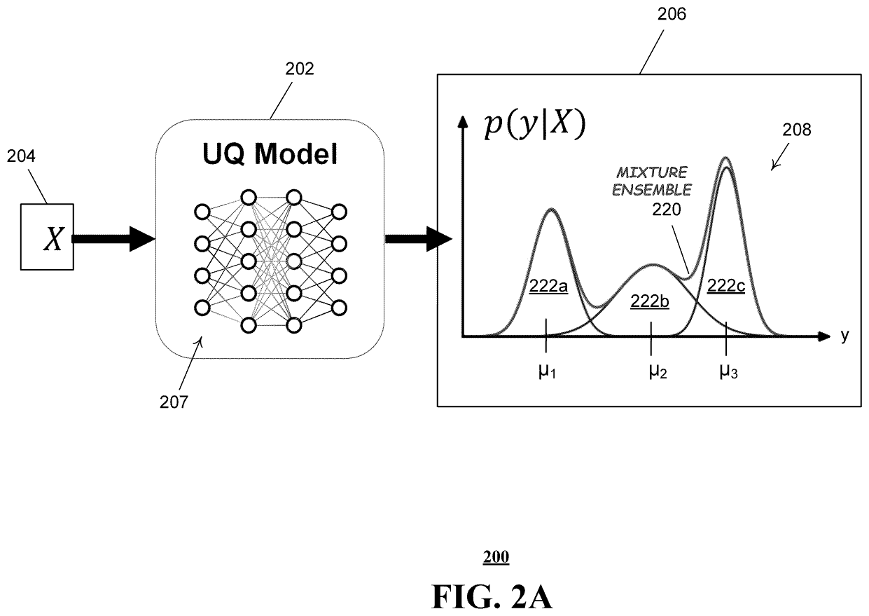

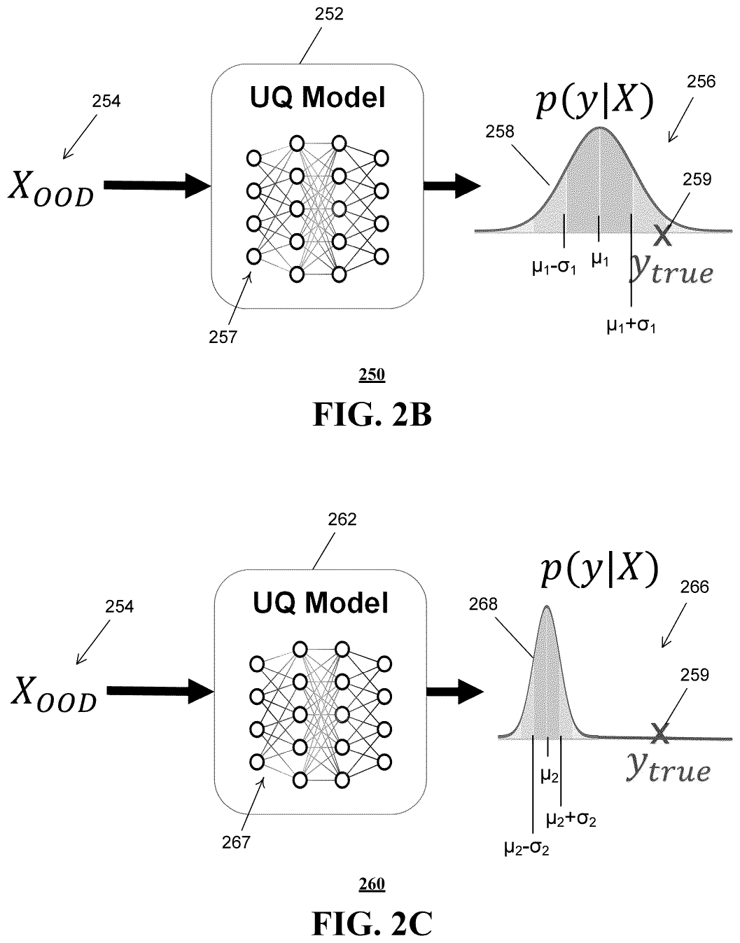

FIG. 2A is a block diagram illustrating an example, non-limiting embodiment of deep mixture ensemble model 200 in accordance with various aspects described herein. According to the illustrative example, the deep mixture ensemble model 200 includes a UQ artificial neural network 202 that receives input features 204 and internally process the input features 204 and provides an output distribution 206. The trained UQ artificial neural network 202 may be further applied to input features 204 to obtain output labels that may be further evaluated in view of the output distribution 206. The example UQ artificial neural network 202 also includes an arrangement of nodes and edges arranged in layers as a DNN 207.

The output distribution 206 may be used to provide and/or otherwise obtain an output distribution 208. According to the illustrative example, the output distribution 208 is described according to a probability density function that identifies a probability or likelihood according to an output value y. In at least some embodiments, the UQ artificial neural network 202 may be reconfigured with different parameters, e.g., weights and/or biases, to obtain different output values y for repeated application of the input value x, the differences resulting from different parameters. The output values may be evaluated to yield a distribution.

It is envisioned that in at least some instances, evaluation of the output distribution 206 may yield multiple distributions that may differ in one or more regards. The distinguishable distributions 222a, 222b, 222c, generally 222, may be similar, e.g., according to the same type of distribution, e.g., normal or Gaussian, as in the illustrative example, or different. In this instance, the distinguishable distributions 222 include a first distinguishable distribution 222a is centered about a first mean μ₁, with a first standard deviation σ₁ (not shown). The distinguishable distributions 222 also include a second distinguishable distribution 222b centered about a second mean μ₂, with a second standard deviation σ₂ (not shown) and a third distinguishable distribution 222c centered about a third mean μ₃, with a third standard deviation σ₃ (also not shown). The distinguishable distributions may be combined, e.g., added, to obtain a single mixture ensemble output distribution 220. For example, the distinguishable distributions 222 may be linearly combined into a single Gaussian approximation of a predictive distribution. The contributing distinguishable distributions 222 are normal or Gaussian distributions, yet collectively, the mixture ensemble output distribution 220 may capture other distribution shapes more generally. Examples include distributions with multiple peaks, e.g., as may be encountered in multi-modal situations and/or heavier tails.

In application, the UQ artificial neural network 202 may provide an output value y that may be determined according to the mixture ensemble output distribution 220 to evaluate whether the model output y is reliable, e.g., having a relatively high value, or less reliable, e.g., being located in one of the valleys or tails of the mixture ensemble output distribution 220. The mixture ensemble output distribution 220 obtained using a DNN 207 of the UQ artificial neural network 202. It may be appreciated that the mixture ensemble output distribution 220 is well suited to capture multimodality, heavy tails, as well as identification of out of distribution (OOD) data.

FIG. 2B is a block diagram illustrating an example, non-limiting embodiment of a UQ model 250 in accordance with various aspects described herein. According to the illustrative example, the UQ model 250 includes UQ artificial neural network 252 that receives input features 254, internally process the input features 254, and provides an output 256. The example UQ artificial neural network 252 also includes an arrangement of nodes and edges arranged in layers as a DNN 257. In at least some embodiments, a model training process may be repeated according to a first process, e.g., using different parameters in the DNN 257 to obtain a first output distribution 258.

According to the first illustrative example, the output distribution is Gaussian, centered about a first mean value μ₁ and having a first standard deviation σ₁ or variance σ₁². The trained UQ artificial neural network 252 may be further applied to input features 254 to obtain an output label 259 that may be further evaluated in view of the first output distribution 258. According to the illustrative example, the output label 259 provides a value of y that falls beyond a first standard deviation of the first output distribution 258, but within a tail of the distribution. Accordingly, the output label 259 would be associated with some measurable assurance of likelihood, e.g., indicating that the output result may be true.

FIG. 2C is a block diagram illustrating an example, non-limiting embodiment of another UQ model 260 in accordance with various aspects described herein. According to the illustrative example, the UQ model 260 includes a UQ artificial neural network 262 that receives input features 254, in this instance, the same input features 254, internally process the input features 254, and provides an output 266. The UQ artificial neural network 262 also includes an arrangement of nodes and edges arranged in layers as a DNN 267. In at least some embodiments, a model training process may be repeated according to a second process, e.g., using different parameters in the DNN 267 to obtain a second output distribution 268.

According to the second illustrative example, the output distribution is also Gaussian, centered about a second mean value μ2 and having a second standard deviation σ₂ or variance σ₂². The trained UQ artificial neural network 262 may be further applied to input features 254 to obtain an output label 259 that may be further evaluated in view of the second output distribution 268. According to the illustrative example, the output label 259 provides a value of y that falls far beyond the second standard deviation, in a miniscule tail of the second output distribution 268. Accordingly, the output label 269 would be highly unlikely, e.g., indicating that the predicted output label 269 should not be relied upon.

To an extent that the DNNs 257, 267 are the same, but for parameter choices, the same out of distribution input features 254 may result in the same, or similar output label 259. However, the uncertainty quantification may be vastly different, as indicated, such that the same output may be viewed as reliable in one instance, and easily identified as being unreliable in another.

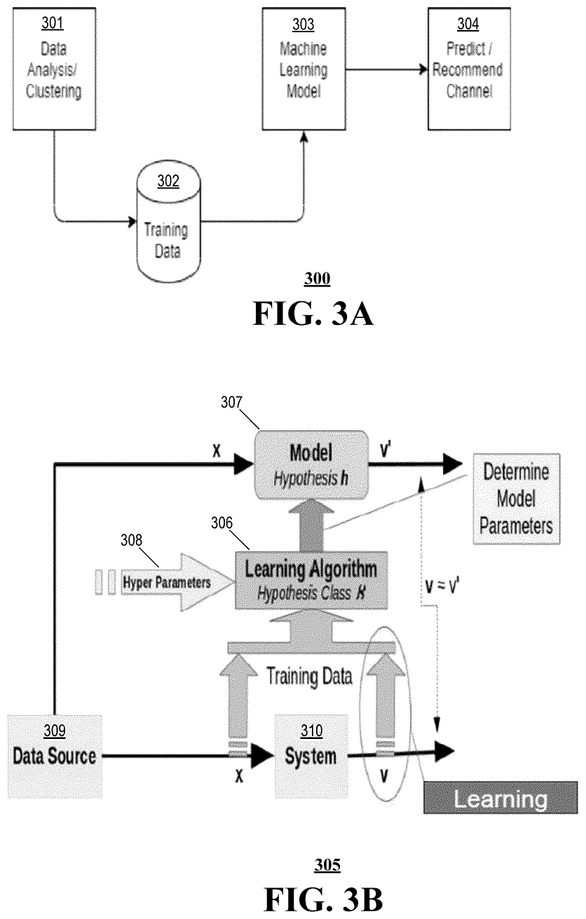

FIG. 3A is a block diagram illustrating an example, non-limiting embodiment of a machine learning system 300 in accordance with various aspects described herein. The example machine learning system 300 includes a data analysis module 301, a training data repository 302, a machine learning module 303 and a recommendation engine 304. The recommendation engine 304 may be adapted to provide a recommended configuration of one or more aspects of any of various practical, real-world problem.

The data analysis module 301 may perform data analysis, which may include, without limitation, summarizing results according to a predetermined success criterion. Alternatively, or in addition, the data analysis may include discovery of patterns, organization of collected data, clustering, and the like, representing data analysis results. In at least some embodiments, the data analysis module 301 may provide one or more elements of the collected and/or the analysis results to a training data repository 302. The training data repository 302, in turn, may store and/or otherwise retain the collected data and/or data analysis results in a retrievable manner. For example, the training data repository 302 may include a matrix of test results and/or a collection of similar matrices. Alternatively, or in addition, the training data repository 302 may store the data in a database system.

The machine learning module 303 may employ one or more machine learning techniques. The machine learning technique(s) may utilize content of the training data repository 302 as training data. In at least some embodiments, the machine learning module 303 may be adapted to identify an input portion of the stored record, e.g., a system configuration and an output portion, e.g., a result of operating the system according to the particular configuration. The machine learning module 303 may formulate a predicted result based on the configuration. According to a training process, the predicted result may be compared to an actual result contained within the training record. The machine learning module 303 may be adapted based on a result of such comparisons. For example, an agreement of the predicted and actual results may represent positive feedback that the model is functioning properly, whereas a disagreement may represent negative feedback. In at least some embodiments, a difference between the predicted result and the actual result may be calculated and interpreted as an error value. It is understood that one or more adjustable features of the machine learning module 303 may be adapted based on the error value. In at least some embodiments, a training process may continue until a success criterion and/or error criterion is observed below a respective threshold.

In at least some embodiments, the data analysis module 301 may collect and/or analyze data of opportunity as may be gathered during routine operation of a system. Data collected in such a manner may be utilized in an ongoing training process, e.g., allowing the machine learning module 303 to formulate a prediction based on the routine data collection and comparing predicted results to observed actual results.

It is understood that the data collection and model training may be applied to data associated with an application, such as a classification, categorization and/or identification and/or forecasting or prediction of a future event. In this regard, the data analysis module 301 may analyze the collected data to obtain analysis results. For example, the analysis results may correlate observed patterns with ancillary information. The analysis results may be stored, e.g., in the training data repository 302 and used to train a machine learning model, such as the example machine learning module 303. It is understood that in at least some embodiments, the machine learning module 303 may be the same one described above in relation to access network configuration and operation. Accordingly, the machine learning module 303 may be trained according to combinations of problem or application specific data as well as utilization and other ancillary information. Training may include using prescribed and/or scripted training data. Alternatively, or in addition, training may include using routine operational data to adapt, enhance and/or otherwise adjust the machine learning system 305.

FIG. 3B is a block diagram illustrating another example, non-limiting embodiment of a machine learning system 305 in accordance with various aspects described herein. The example machine learning system 305 includes a learning algorithm 306 and a model 307. The model 307 may be initialized, modified, adapted and/or otherwise trained according to the learning algorithm 306. The model 307 receives input data from a data source 309, represented by “x,” and generates a predicted output, represented by “v′.” In at least some instances the data source 309 provides the same input data “x” to an actual, e.g., a physical system 310, to obtain an actual output “v.” A set of training data may be generated according to a pairing of the actual input and output of the physical system 310, x and v. The training data may be processed by the learning algorithm 306 to obtain learned relationships between the actual and training data. In at least some embodiments, the model 307, may be adapted according to the learned relationships to apply a hypothesis to subsequent input data.

In at least some embodiments, a training process trains the model 307 according to an application of the learning algorithm 306, as may have been derived and/or otherwise configured from the training data. A trained model 307 may receive subsequent data from the data source 309 and provide a predicted output v′ according to hypotheses of the trained model 307. In at least some instances, the same data from the data source 309 may be applied to the physical system 310 to obtain an actual output v. The actual output v may be compared to the predicted output v′ to determine an error. To the extent the predicted and actual outputs agree the model 307 is suitably trained. However, to the extent the predicted and actual output disagree, the model 307 may require further training. In at least some embodiments, a tolerable error rate may be established as a threshold value, such that errors below the threshold may initiate further training, whereas errors above the threshold may not. Example error thresholds may be established according to a particular problem or class of problems or application(s).

It is understood that in at least some embodiments, the learning algorithm 306 may be adjustable via one or more hyper parameters 308. The hyper parameters 308 may be provided and/or otherwise modified responsive to an observed error. It is understood further that the training process may be performed once, e.g., during a system configuration period, periodically, e.g., responsive to an event, such as a system failure and/or reconfiguration, according to a schedule, e.g., periodically, such as hourly, daily, weekly, and so on. In at least some embodiments, the performance operation and/or training process may be performed in a substantially continuous manner, such that predictions provided by the model 307, may be implemented within the physical system 310 to obtain actual results that may be compared with predicted results as described above.

By way of example, a deep Gaussian mixture ensemble problem formulation may include consideration of a set of training data:

$$𝒟 = {\{ ( {x}_{n} , {y}_{n} ) \}}_{n = 1}^{N} ,$$

In which xₙ∈ [symbol] ^{d}^{ₓ} represents a feature vector and yₙ represents an output. Without limitation, the output may be real-valued if dealing with a regression task or integer-valued if dealing with a classification task. A model may be trained that allows for prediction of an output y given its corresponding input vector x. From a probabilistic perspective, at least one goal would be to determine a posterior predictive distribution p(y|x,D). A statistical model p_{θ}(y|x)≙p(y|x,θ) may be assumed that relates each output to its corresponding feature vector through a set of parameters θ∈Θ. Then, the predictive distribution may be determined as:

$$p ( y \vert x , D ) = {\int }_{Θ} {p}_{θ} ( y \vert x ) p ( θ \vert 𝒟 ) d θ \qquad ( 1 )$$

While this integral is generally intractable, it can be approximated using a Monte Carlo average, where samples are taken from the posterior p(θ|D). Let Y={y₁, . . . ,y_{N}} and let X={x₁, . . . ,x_{N}}. According to Bayes theorem, the posterior distribution p(θ|D) is:

$$p ( θ \vert 𝒟 ) = \frac{p ( Y \vert X , θ ) p ( θ )}{p ( Y \vert X )} , \qquad ( 2 )$$

In which p(Y|X, θ)=Πₙ₌₁^{N}p_{θ}(yₙ|xₙ) may be referred to as a “data likelihood” under an independent and identically distributed (i.i.d.) assumption, p(θ) is the prior distribution of θ, and p(Y|X)=∫_{Θ}p(Y|X, θ)p(θ)dθ is called the marginal likelihood. The posterior can only be computed analytically when p(θ) is a conjugate prior for the likelihood function p(Y|X,θ). For deep learning models, an analytical solution to the posterior cannot be determined and one must resort to an approximation of the predictive distribution.

In at least some embodiments, an approximation of the posterior predictive distribution may be acquired. For example, samples from the approximation form consistent estimators of key moments of the predictive distribution that allow one to: (i) formulate predictions; (ii) identify the underlying stochastic risk associated with the prediction, e.g., aleatoric uncertainty; and/or (iii) reason about the model's uncertainty in the presence of the OOD data, e.g., epistemic uncertainty.

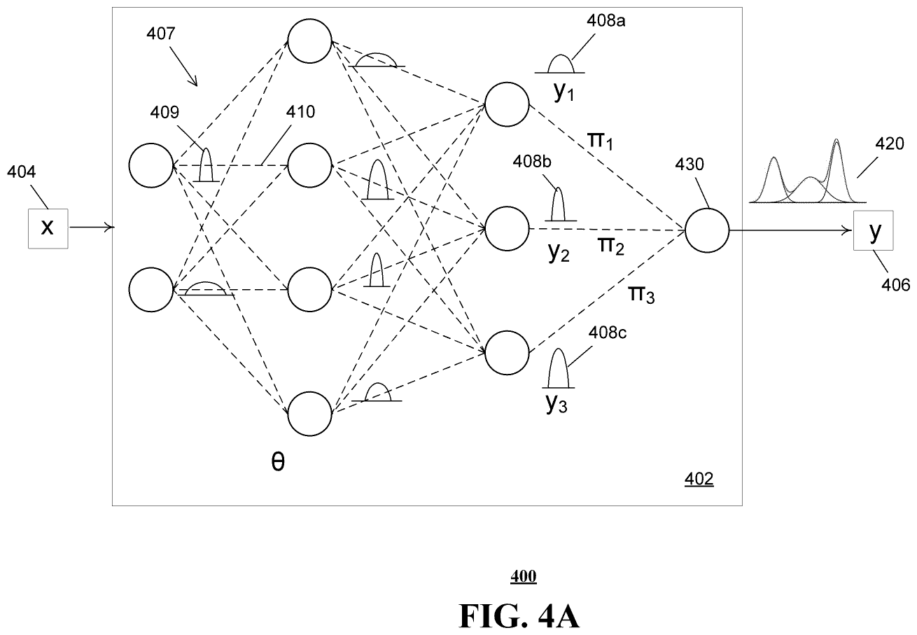

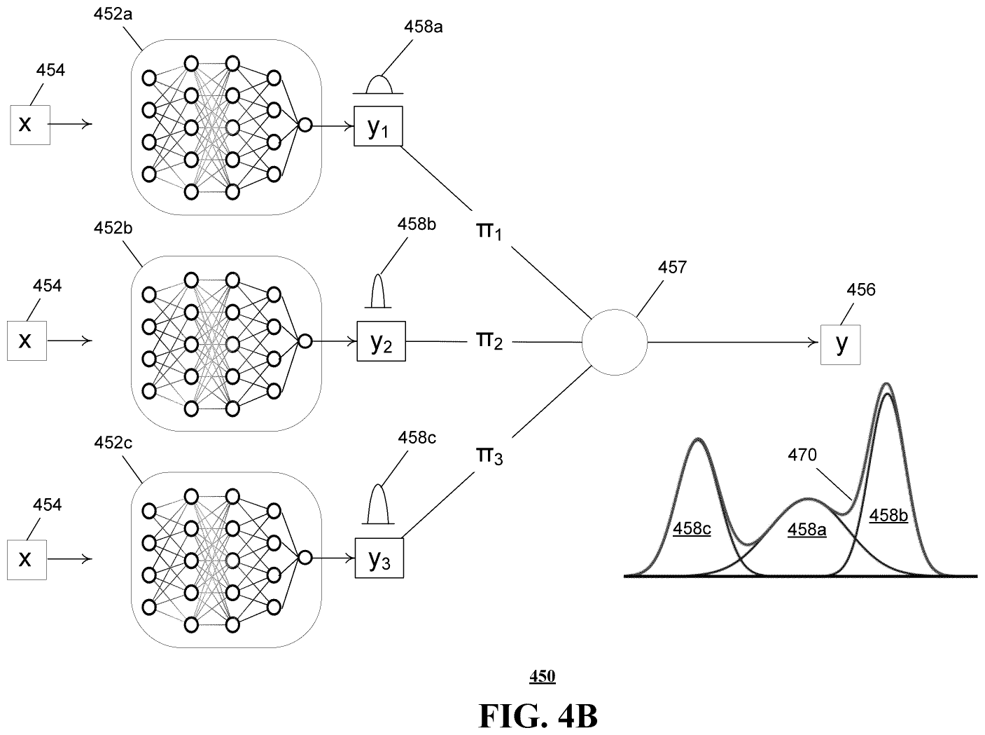

FIG. 4 is a block diagram illustrating another example, non-limiting embodiment of deep mixture ensemble model 400 in accordance with various aspects described herein. According to the illustrative example, the deep mixture ensemble model 400 includes a UQ artificial neural network 402 that receives input features 404 and internally processes the input features 404 and provides an output value 406. The trained UQ artificial neural network 402 may be further applied to input features 404 to obtain output labels that may be further evaluated in view of the output value 406. The example UQ artificial neural network 402 also includes an arrangement of nodes and edges arranged in layers as a DNN 407.

The output value 406 may be used to provide and/or otherwise obtain multiple output values y₁, y₂, y₃, or mixture components, generally, mixture component y, that may be evaluated, e.g., repeated, to obtain respective probability density distributions 208a, 208b, 208c, generally 208. According to the illustrative example, the output distributions 208 are described according to respective probability density functions that identify probabilities or likelihoods according to a respective mixture component y. In at least some embodiments, the UQ artificial neural network 202 may be reconfigured with different parameters θ, e.g., weights and/or biases, to obtain different mixture components y for repeated application of the input value x, the differences resulting from different parameters. The output values may be evaluated to yield a distribution.

It is understood that in at least some embodiments, one or more of the weights and/or biases may be described probabilistically. A statistical model may be applied, e.g., in which a probability may be applied to a labeling according to particular values of the parameters θ. This may be represented as p_{θ}(y|x)=p(y,x,θ). The statistical model relates each output to its corresponding input or feature vector through the set of parameters θ. The example DNN 407 illustrates respective distributions of network parameters 409 for each network edge 410, in which the distributions 408a, 408b, 408c, generally 408, correspond to probability density functions. It is envisioned that in at least some embodiments distributions may be separately obtained for bias values. Model parameters may be determined during a training process to identify parameters θ of the DNN 407 that result in output distributions 408, e.g., Gaussian distributions according to μ,σ, that lead to a highest or maximum likelihood for y.

In at least some embodiments, the UQ artificial neural network 202 may be configured by selecting network parameters, e.g., weights and/or biases, for one or more of the network edges 410, and configuring the DNN 407 according to the selected parameters. The configured DNN 407 may next be presented with input features 404 to produce respective mixture components π₁, π₂, π₃, which may be combined, e.g., linearly, to obtain an output value 406. The process may be repeated for other network configurations, e.g., determined according to other samples for the network parameters 409 to obtain a distribution 408 of output values y.

It is envisioned that in at least some instances, evaluation of the mixture components y may yield multiple distributions that may differ in one or more regards. The distinguishable distributions 408, may be similar, e.g., according to the same type of distribution, e.g., normal or Gaussian, as in the illustrative example, or different. In this instance, the distinguishable distributions 408 include a first distribution 408a is centered about a first mean μ₁, with a first standard deviation σ₁ (not shown). The distinguishable distributions 408 also include a second distribution 408b centered about a second mean μ₂, with a second standard deviation σ₂ (not shown) and a third distribution 408c centered about a third mean μ₃, with a third standard deviation σ₃ (also not shown). The distinguishable distributions 408 may be weighted according to respective weighting values, π₁, π₂, π₃, combined, e.g., added, to obtain a single mixture ensemble output distribution 420. For example, the distinguishable distributions 408 may be weighted and linearly combined into a single Gaussian approximation of a predictive single mixture ensemble output distribution 420. The contributing distinguishable distributions 408 are normal or Gaussian distributions, yet collectively, the mixture ensemble output distribution 420 may capture other distribution shapes more generally. Examples include distributions with multiple peaks, e.g., as may be encountered in multi-modal situations and/or heavier tails.

In application, the UQ artificial neural network 402 may provide an output value 406 that may be determined according to the mixture ensemble output distribution 420, e.g., to evaluate whether the model output y is reliable by indicating whether the output value 406 has a relatively high value, or less reliable, e.g., being located in one of the valleys or tails of the mixture ensemble output distribution 420. The mixture ensemble output distribution 420 obtained using the DNN 407 of the UQ artificial neural network 402. It may be appreciated that the mixture ensemble output distribution 420 is well suited to capture multimodality, heavy tails, as well as identification of out of distribution (OOD) data.

According to the illustrative example, the UQ artificial neural network 402 includes an output layer 430 that performs a linear combination of the respective output distributions 408. The DNN 407 predicts several normal output distributions 408, and the output layer performs an activation function that combines the distributions according to mixing coefficients. It is understood that in at least some embodiments, the mixing coefficients may also be learned by the deep mixture ensemble model 400. Accordingly, the normal output distributions 408 are linearly combined into a single Gaussian approximation of the single mixture ensemble output distribution 420. In this manner, modeling the conditional density p_{θ}(y|x) as a Gaussian mixture allows for learning more complex distributions, such as skewed, heavy-tailed, and multimodal distributions.

FIG. 4B is a block diagram illustrating yet another example, non-limiting embodiment of deep mixture ensemble model 450 in accordance with various aspects described herein. According to the illustrative example, the deep mixture ensemble model 450 includes a first UQ artificial neural network 452a that receives input features 454 and internally process the input features 454 and provides a respective output distribution 458a. Likewise, the deep mixture ensemble model 450 includes second and third UQ artificial neural networks 452b, 452c that receive input features 454 and internally process the input features 454 and provide respective output distributions 458b, 458c. The trained UQ artificial neural networks 452a, 452b, 452c, generally 452, may be further applied to input features 454 to obtain output labels y₁, y₂, y₃ that may be further evaluated in view of the output distributions 458a, 458b, 458c, generally 458.

The deep mixture ensemble model 450 may be used to provide and/or otherwise obtain mixture coefficients π₁, π₂, π₃, generally, mixture coefficient T. According to the illustrative example, the output distributions 458 are described according to respective probability density functions that identify probabilities or likelihoods according to a respective mixture component y. The output distributions 458 may be combined in a mixing node 457 to obtain an output 456 according to their respective mixing coefficients to obtain a deep gaussian mixture ensemble distribution 470 that provides a measure of uncertainty.

According to the illustrative example, the UQ artificial neural networks 452 may represent the same network trained according to different parameters θ. Alternatively, or in addition, the UQ artificial neural networks 452 may represent different DNNs that may include a different arrangement of nodes and/or edges. For example, different nodal configurations may be obtained using a dropout technique in which some nodes are effectively removed from the DNN. Selection of the nodes for removal may be determined according to a random selection process, e.g., as may be obtained using a Monte Carlo dropout technique.

It is understood that in at least some embodiments, deep Gaussian mixture ensembles (DGMEs) may be applied to effectively learn a mixture distribution that accurately represents the true conditional density of the labels given the features. Since Gaussian mixtures are universal approximators for smooth probability density functions, modeling the conditional density p_{θ}(y/x) as a Gaussian mixture allows for learning more complex distributions, such as skewed, heavy-tailed, and multimodal distributions. Under the assumption that the example data follows a mixture distribution with K mixture components, the conditional density of a particular example (x,y) is given by:

$${p}_{θ} ( y \vert x ) = {\sum }_{k = 1}^{K} {π}_{k} {p}_{k} ( y \vert x , {θ}_{k} ) , \qquad ( 3 )$$

where θₖ∈Θₖ⊆R^{d}^{_{θ}} denotes the underlying parameters of the k-th mixture and πₖ denotes the weight of the k-th mixture and represents the probability that the example (x,y) is distributed according to pₖ(y|x,θₖ). For convenience, all unknown parameters in the mixture may be simply referred to as θ={π₂,θ₁, . . . , π_{K},θ_{K}}. Hereafter, the problem of learning the parameters of the mixture in (3) is considered according to a context of regression. It is understood that other extensions to classification are possible.

In at least some embodiments, certain assumptions may be applied to effectively model this mixture. For example, it may assumed that mixture weights (π₁, . . . , π_{K})∈S_{K} do not depend on the input features, where S_{K} denotes the K-dimensional probability simplex. Alternatively, or in addition, it may be assumed that conditional density pₖ(y|x,θₖ) is a Gaussian distribution whose parameters are modeled via parameterized functions (neural networks) dependent on x:

$${p}_{k} ( y \vert x , {θ}_{k} ) = 𝒩 ( y ; {μ}_{{θ}_{k}} ( x ) , {σ}_{{θ}_{k}}^{2} ( x ) ) , \qquad ( 4 )$$

where θₖ denote the parameters of functions μ_{θ}_{ₖ}(⋅) and σ_{θ}_{ₖ}² (⋅) that output the mean and variance of the k-th mixture, respectively. Importantly, these functions are assumed to share parameters, just as in the original work on DEs.

Under the above assumptions, learning the mixture representation of p_{θ}(y|x) is equivalent to learning the parameters θ to maximize the data likelihood of the training examples:

$$𝒟 = {\{ ( {x}_{n} , {y}_{n} ) \}}_{n = 1}^{N} .$$

In at least some embodiments, the mixing parameters may be learned. A maximum likelihood (ML) estimate or maximum a posteriori (MAP) estimate of the unknown parameters θ may be obtained using an expectation maximization (EM) algorithm. Let Y={y₁, . . . ,y_{N}} and X={x₁, . . . ,x_{N}}. Furthermore, let Z={z₁, . . . ,z_{N}}, where each zₙ∈{1, . . . ,K} is a latent variable that denotes membership assignment of the training example (xₙ,yₙ) to a particular mixture component, where πₖ≙P_{θ}(zₙ=k) is the probability that the example (xₙ,yₙ) belongs to the k-th component. Assuming that the training examples are independent and identically distributed, the joint likelihood may be expressed as:

$${p}_{θ} ( Y , Z \vert X ) = {\prod }_{n = 1}^{N} {\prod }_{k = 1}^{K} {π}_{k}^{I ( {z}_{n} = k )} {𝒩 ( {y}_{n} ; {μ}_{{θ}_{k}} ( {x}_{n} ) , {σ}_{{θ}_{k}}^{2} ( {x}_{n} ) )}^{I ( {z}_{n} = k )} ,$$

with a corresponding log-likelihood of:

$$log {p}_{θ} ( Y , Z \vert X ) = {\sum }_{n = 1}^{N} {\sum }_{k = 1}^{K} I ( {z}_{n} = k ) ( log {π}_{k} + {l}_{{θ}_{k}} ( {x}_{n} , {y}_{n} ) ) , \\ in which$$

$${ℓ}_{{θ}_{k}} ( x , y ) = log ( 𝒩 ( y ; {μ}_{{θ}_{k}} ( x ) , {σ}_{{θ}_{k}}^{2} ( x ) ) ) .$$

At least one goal is to solve the following optimization problem:

$$\begin{matrix}{θ}^{★} & = & {arg max}_{θ} log {p}_{θ} ( Y \vert X ) & ( 5 ) \\ & = & {arg max}_{θ} log ( {𝔼}_{Z \vert X , Y , θ} [ {p}_{θ} ( Y , Z \vert X ) ] ) , & ( 6 )\end{matrix}$$

which may be numerically solved using an expectation maximization (EM) algorithm. In the following, both the expectation step (E-Step) and maximization step (M-Step) as described as they relate to a model. As a note, all results presented hereafter also apply to the more general problem of obtaining the MAP estimate of the parameters θ. That is, the maximizer of log p(Y,θ|X)=log p_{θ}(Y|X)+log p(θ), where p(θ) is the prior distribution of the mixture parameters.

E-Step: the posterior probabilities of each zₙ may be updated given the parameters θ and the example (xₙ,yₙ) for each n, denoted by γ_{k,n}≙P_{θ}(zₙ=k|xₙ,yₙ). This can be done directly using Bayes' theorem:

$$\begin{matrix}{γ}_{k , n} & = & \frac{{p}_{k} ( {y}_{n} \vert {x}_{n} , {θ}_{k} ) {P}_{θ} ( {𝓏}_{n} = k )}{{\sum }_{j = 1}^{K} {p}_{j} ( {y}_{n} \vert {x}_{n} , {θ}_{j} ) {P}_{θ} ( {𝓏}_{n} = j )} & ( 7 ) \\ & = & \frac{{π}_{k} 𝒩 ( {y}_{n} ; {μ}_{{θ}_{k}} ( {x}_{n} ) , {σ}_{{θ}_{k}}^{2} ( {x}_{n} ) )}{{\sum }_{j = 1}^{K} {π}_{j} 𝒩 ( {y}_{n} ; {μ}_{{θ}_{j}} ( {x}_{n} ) , {σ}_{{θ}_{j}}^{2} ( {x}_{n} ) )} & ( 8 )\end{matrix}$$

M-Step: The parameters θ are updated in the maximization step by maximizing the expected joint log-likelihood Q(θ,θ′)≙E_{Z|X,Y,θ′}[log p_{θ}(Y,Z|X)] given the previous parameter values θ′, which is equivalent to doing lower-bound maximization on the true log-likelihood. The function Q(θ,θ′) can be readily determined as:

$$Q ( θ , {θ}^{′} ) = {\sum }_{n = 1}^{N} {\sum }_{k = 1}^{K} {γ}_{k , n} ( log ( {π}_{k} ) + {l}_{{θ}_{k}} ( {x}_{n} , {y}_{n} ) ) . \qquad ( 9 )$$

The optimization of the mixture weights (π₁, . . . , π_{K}) can be carried out analytically and done independently of optimizing the mixture parameters {θ₁, . . . ,θ_{K}}:

$$( {π}_{1}^{★} , … , {π}_{K}^{★} ) = arg max Q ( θ , {θ}^{′} ) , \\ ( {π}_{1} , … , {π}_{K} ) ∈ {S}_{k} \qquad ( 10 )$$

where for each k,

$${π}_{K}^{★} = \frac{1}{N} {\sum }_{n = 1}^{N} {γ}_{k , n} . \qquad ( 11 )$$

Since the mixture parameters are assumed to be parameterized by neural networks, their optimization must be carried out using stochastic optimization. It is easy to see that the optimization of each θₖ can be done independently as:

$$\begin{matrix}{θ}_{k}^{★} & = & {arg max}_{{θ}_{k} ∈ {Θ}_{k}} {\sum }_{n = 1}^{N} {γ}_{k , n} {ℓ}_{{θ}_{k}} ( {x}_{n} , {y}_{n} ) & ( 12 ) \\ & = & {arg max}_{{θ}_{k} ∈ {Θ}_{k}} {\sum }_{n = 1}^{N} {γ}_{k , n} ( log {σ}_{{θ}_{k}}^{2} ( {x}_{n} ) + \frac{{( {y}_{n} - {μ}_{{θ}_{k}} ( {x}_{n} ) )}^{2}}{{σ}_{{θ}_{k}}^{2} ( {x}_{n} )} ) & ( 13 )\end{matrix}$$

This optimization step can be thought of as training a deep ensemble, where each sample (xₙ,yₙ) is weighted by γ_{k,n} in its negative log-likelihood contribution.

Implementation of DGMEs trained via the EM algorithm is summarized in Algorithm 1. To initialize the ensemble, the parameters of each network in the ensemble are randomly initialized, while the mixture weights are assumed to be equal. The algorithm is run for J steps or alternatively until some stopping criterion is met. The E-Step for updating the posterior probabilities is computed directly for each sample in the training set. In the M-Step, the updates for the mixture weights are also carried out analytically, but for mixture component parameters θₖ the stochastic optimization may be used to numerically solve for the updates, as an analytical solution is not available. At round j, each network may be initialized to θₖ^{(j-1)} and then run the Adam optimizer for E epochs to minimize the weighted negative log-likelihood in Eq. 13, where the weights are given by γ_{k,n}_{⁽ⁱ⁾} for all n. It may be noted that the computational complexity of each EM step is equivalent to that of DEs and the overall time complexity scales linearly with the number of EM steps.

In at least some embodiments, epistemic uncertainty may be quantified. It is important to highlight that up until this point, epistemic uncertainty in DGMEs has not been specifically addressed. This is because the operation of training DGMEs according to Algorithm 1 yields a single set of parameters of the assumed Gaussian mixture model. This point highlights an intrinsic difference in training DEs versus training DGMEs. DGMEs do not require a “Bayesian” interpretation, because the EM algorithm used to train them only outputs a single set of possible parameters for the DGMEs, e.g., corresponding posterior distribution of the weights is a Dirac measure centered at the learned parameter values). To account for model uncertainty, it is necessary to account for the uncertainty in the parameters of the mixture (i.e., the mixture weights and/or the weights of the ensemble neural networks). At least one approach to accomplish this is to apply MCD to the training procedure of DGMEs—although it may be emphasized that other techniques can be applied to account for epistemic uncertainty, e.g., Laplace approximation or a variational approximation to the posterior parameters.

Let aₖ=[a_{k,1}, . . . ,a_{k,dθ}]^{T}∈{0,1}^{d}^{_{θ}} denote a random binary vector of the same size as each θₖ and let p_{d}∈[0,1] denote a fixed dropout probability. Also, let θ*={π₁*, θ₁*, . . . ,π_{K}*, θ_{K}*} denote the parameters learned by running Algorithm 1 with dropout incorporated in the training in the M-Step.

TABLE 1
Algorithm 1.
Algorithm 1 Deep Gaussian Mixture Ensembles (DGMEs)

```
1: Inputs:
    • Training dataset [symbol]  = {(xₙ, yₙ)}ₙ₌₁^{N}
    • Number of mixture components K
    • Number of EM steps J
2: Initialize mixture parameters:
    • Sample θₖ⁽⁰⁾ ~ p(θ) for all k,
    $Set {π}_{k}^{( 0 )} = \frac{1}{K} for all k .$
3: for j = 1, ... , J do
4:  E-Step: Update posterior probabilities γ_{k,n}^{(j)} according to (8) with mixture weights
    πₖ^{(j-1)} and mixture parameters θₖ^{(j-1)} for all k and n.
5:  M-Step: Update mixture weights πₖ^{(j)}, and parameters θₖ^{(j)}; for all k as
${π}_{k}^{( j )} = \frac{1}{N} {\sum }_{n = 1}^{N} {γ}_{k , n}^{( j )}$
    and
${θ}_{k}^{( j )} = {arg max}_{{θ}_{k} ∈ {θ}_{k}} {\sum }_{n = 1}^{N} {γ}_{k , n}^{( j )} {ℓ}_{{θ}_{k}} ( {x}_{n} , {y}_{n} )$
6: end for
7: Return: πₖ* = πₖ^{(J)} and θₖ* = θₖ^{(J)} for all k.
```

For a given mixture component k, samples from the approximate posterior distribution of θₖ learned via dropout can be obtained via the following procedure:

$${a}_{k , i} ∼ Bernoulli ( {p}_{d} ) , i = 1 , … , {d}_{θ} , \\ {θ}_{k} = {a}_{k} ⊙ {θ}_{k ★} ,$$

in which ⊙ denotes a Hadamard (or elementwise) product. It follows that a sample from the predictive distribution can directly be obtained as follows:

$$k ∼ Categorical ( {π}_{1} , … {π}_{K} ) , \qquad ( 14 )$$

$${a}_{k , i} ∼ Bernoulli ( pd ) , i = 1 , … , d θ , \qquad ( 15 )$$

$${θ}_{k} = {a}_{k} ⊙ {θ}_{{k}^{★}} , \qquad ( 16 )$$

$$y ∼ {p}_{k} ( y \vert x , {θ}_{k} ) . \qquad ( 17 )$$

In this procedure, one first samples the mixing component k via Eq. 14. Then, one draws a sample from the approximate posterior distribution of the parameters of the k-th mixture via Eqs. 15-16. Finally, a prediction can be sampled via Eq. 17. The supplementary material provided in Section D provides details on the validity of this sampling procedure.

The following discussion provides further insight into connections between DGMEs and DEs, along with general results on convergence of the example training procedure using DGMEs. It is understood that maximizing a data likelihood directly as in DGMEs may achieve an equal or better likelihood than maximizing each ensemble member's likelihood separately as in DEs. For example, under an assumption that πᵢ=1/K for I=1, . . . ,K−1, maximizing a Gaussian mixture data likelihood directly achieves better or equal joint likelihood than maximizing each ensemble member's likelihood separately. By way of support, the result can be obtained by using Jensen's inequality on the joint log-likelihood of equation (5) along with the assumption.

It is understood that a combination of recent results on neural network convergence in regression with classical EM analysis provides intuition on why DGMEs should converge towards a maximum of the data likelihood. In at least some embodiments, a non-flatness of the weighted log-likelihood may be assumed. In view of this assumption, given a DGMEs with K mixtures, in each EM round t there exists an ϵ_{t,k} such that:

$${\sum }_{n = 1}^{N} {γ}_{k , n} ( {ℓ}_{{θ}^{★}} ( {x}_{n} , {y}_{n} ) - {ℓ}_{{θ}^{( t )}} ( {x}_{n} , {y}_{n} ) ) \geq \frac{{ϵ}_{t , k}}{K} , \qquad ( 18 )$$

where

$${θ}_{{k}^{*}} = arg {max}_{θ ∈ Θ} {\sum }_{n = 1}^{N} {γ}_{k , m} {ℓ}_{θ} ( {x}_{n} , {y}_{n} ) .$$

Let ϵ=min_{t∈T,k∈K∈t,k}.

In at least some embodiments, a smoothness of the true mean function may be assumed. In view of this assumption, let μ(x): X→R be the true mean function and let X⊂X. Assume there exists some β∈N⁺ such that μ(x)∈W^{β,∞}(X), where W^{β,∞}(X) is a (β,∞)-Sobolev ball.

In at least some embodiments, a smoothness of the true variance function may be assumed. In view of this assumption, let σ(x): X→R⁺ represent a true variance function and let X⊂X. Let H^{∞} represent a Graham matrix, and assume that there exists an M∈R such that σ(x)^{T}(H^{∞})σ(x)^{T}≤M for some M∈ [symbol] .

In at least some embodiments, a non-degenerate weights may be assumed. In view of this assumption, each EM iteration, the weights are positive and bounded away from zero,

$$e . g . , {π}_{i}^{( t )} > {ξ}_{i}^{( t )} > 0. \qquad ( 19 )$$

It is understood that in view of the foregoing assumptions, the mean and variance in each ensemble model may be estimated via a separate 2-layer deep ReLU network from a common feature extraction layer. Then the DGMEs EM algorithm convergences to a non-stationary point that maximizes the data likelihood with high probability. The result follows upon a showing that Q(θ;θ^{(j)}) is an increasing function of the EM steps j, for parameter values θ^{(j)} that are not stationary points of Q(θ;θ^{(j)}). In the DGMEs case, this corresponds to proving that the weighted log-likelihood in each ensemble increases at every round j. The result follows by combining assumptions on the non-flatness of the weighted log-likelihood, the smoothness of true mean function and the smoothness of the true variance function, e.g., with results obtained about convergence of deep ReLU networks.

It is understood that if the weights of each ensemble member are initialized to 0 with fixed bias terms, a single EM step for DGMEs can be equivalent to performing DEs. This effectively connects DGMEs and DEs, showing that a DE can be considered as equivalent to a single-EM-step of a DGME under specific neural network weights initialization. The EM training of DGME improves the function Q at each iteration t, e.g. Q(θ^{(t+1)},θ^{(t)}≥Q(θ^{(t)},θ^{(t)}). Hence, a final joint DGME likelihood will tend to be larger or equal to the joint likelihood achieved by DE. An initialization schema implies that mixture membership is equal across samples in the first expectation round of the EM. Hence, the first M-step consists in training K separate networks with each log-likelihood contribution being weighted equally.

The empirical performance of DGMEs may be evaluated via different experiments, e.g., three different numerical experiments. The disclosed process is compared to MDNs, MCD, and DEs. MCD and DEs, as examples of other sophisticated solutions for quantifying predictive uncertainty in deep learning models and have repeatedly been used as baselines for developing new techniques.

TABLE 2
Average RMSE of test examples for regression experiments on real datasets.
TEST RMSE

| Dataset | MDNs | MCD | DEs | DGMEs (J = 1) | DGMEs (J = 2) | DGMEs (J = 5) | DGMEs (J = 10) |
|---|---|---|---|---|---|---|---|
| Boston housing | 2.79 ± 0.84 | 2.97 ± 0.85 | 3.28 ± 1.00 | 3.11 ± 0.94 | 3.00 ± 0.90 | 2.87 ± 0.86 | 2.83 ± 0.91 |
| Concrete | 5.21 ± 0.56 | 5.23 ± 0.53 | 6.03 ± 0.58 | 5.67 ± 0.57 | 5.36 ± 0.51 | 5.20 ± 0.59 | 5.14 ± 0.58 |
| Energy | 0.71 ± 0.14 | 1.66 ± 0.19 | 2.09 ± 0.29 | 2.01 ± 0.29 | 1.79 ± 0.24 | 1.22 ± 0.25 | 1.07 ± 0.41 |
| Kin8nm | 0.08 ± 0.00 | 0.10 ± 0.00 | 0.09 ± 0.00 | 0.08 ± 0.00 | 0.08 ± 0.00 | 0.07 ± 0.00 | 0.07 ± 0.00 |
| Power plant | 4.12 ± 0.17 | 4.02 ± 0.18 | 4.11 ± 0.17 | 4.12 ± 0.16 | 4.10 ± 0.15 | 4.07 ± 0.15 | 4.05 ± 0.13 |
| Wine | 0.66 ± 0.04 | 0.62 ± 0.04 | 0.64 ± 0.04 | 0.63 ± 0.04 | 0.64 ± 0.04 | 0.64 ± 0.04 | 0.66 ± 0.05 |
| Yacht | 0.96 ± 0.36 | 1.11 ± 0.38 | 1.58 ± 0.48 | 0.98 ± 0.38 | 0.85 ± 0.36 | 0.83 ± 0.40 | 0.70 ± 0.26 |

It may be observed from this table that DGMEs obtain competitive or better performance in terms of RMSE on the majority of datasets as compared to the baselines.

An example model regarding a heavy-tailed toy regression is provided for evaluation:

$$n = {u}_{n} {x}_{n}^{3} + {ϵ}_{n} , \qquad ( 20 )$$

According to Eq. 20, uₙ∈{−1,1} with pᵤ≙P(uₙ=−1) and ϵₙ˜p(ϵ) for all n=1, . . . ,N. A large number of training samples, e.g., N=800 training samples are generated from the example model for the training set, where the input values xₙ range from −4 to 4. For each considered setting, a learning rate of η=0.01, a batch size of 32, and E=80 epochs are used to resolve the stochastic optimization problem in the M-step. For each method, a dropout probability p_{d}=0.1 is utilized to account for epistemic uncertainty. Additionally, data from this toy model is generated under three different noise settings to demonstrate the flexibility and expressive power of DGMEs as compared to other baselines. Unless otherwise stated, it may be assumed that K=5 networks in each mixture model-based approaches, e.g., MDNs, DEs, and DGMEs. Experimental results are described below for each noise scenario.

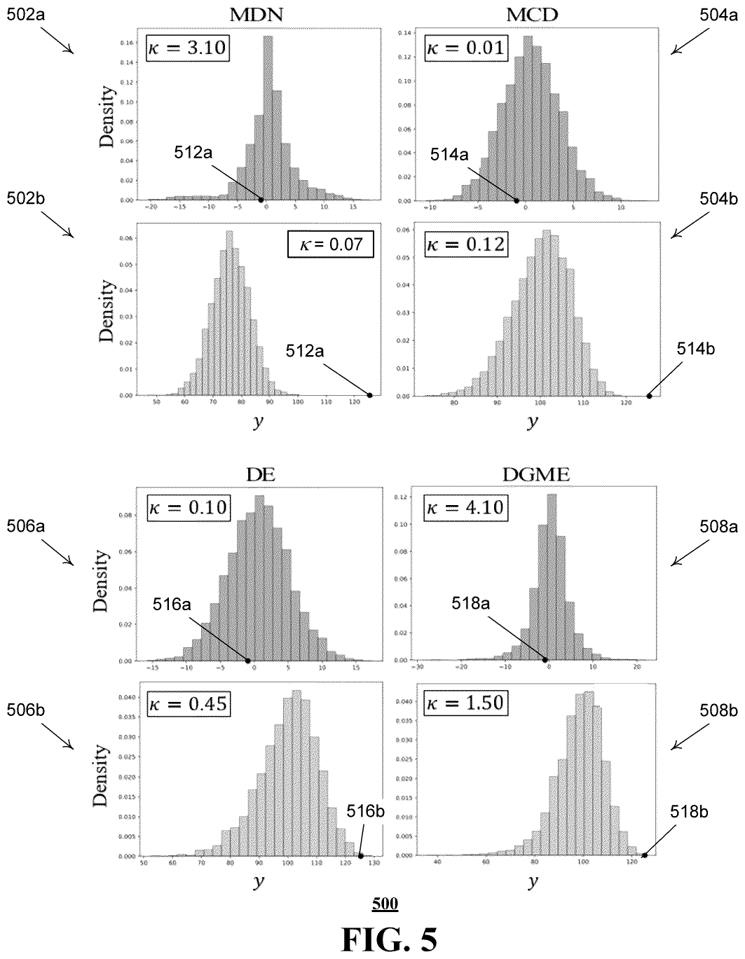

FIG. 5A is a deep-ensemble performance graph 500 illustrating an example performance of an example, non-limiting embodiment of a deep ensemble model in accordance with various aspects described herein. In more detail, FIG. 5 provides example histograms of samples from the predictive distributions for a single training example 502a, 504a, 506a, 508a, with p(y|x=0,D), and for a single test example 502b, 504b, 506b, 508b, with p (y|x=5,D), from the heavy-tailed toy regression example, shown with corresponding sample kurtosis values K. A kurtosis value represents a measure of how much data resides in tails of a distribution. DGMEs generally estimate heavier tailed predictions, reflecting larger kurtosis values for both training and test samples, while baseline approaches samples are closer to following a Gaussian distribution. Also reflected in the examples are, so called, ground truth values 512a, 512b, 514a, 514b, 516a, 516b, 518a, 518b.

A first evaluation case relates to Gaussian noise, in which a value pᵤ=0 may be set to zero with an assumption that the noise is zero-mean, and Gaussian distributed with variance of 9. A performance of DGMEs as compared to the example baselines outperforms MDNs and obtains comparable results to MCD and DEs.

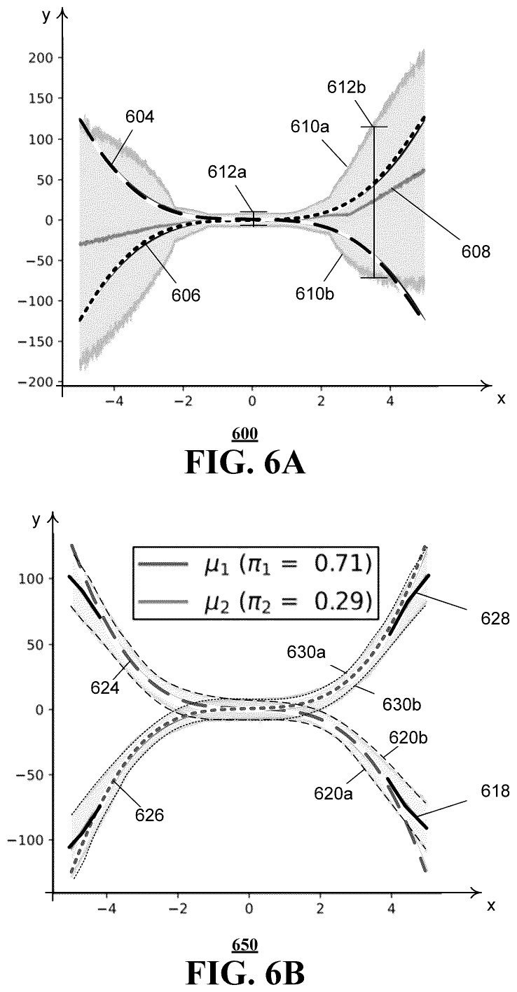

FIG. 6A is a deep-ensemble (DE) performance graph 600 providing example predictive distribution plots for a bimodal Gaussian toy regression example in accordance with various aspects described herein. A first dashed curve represents a grounded truth of a first mode 604 and a second dotted curve represents a grounded truth of a second mode 606. The first and second modes 604, 606 are relatively close in a central region 612a and substantially different in the extreme regions, e.g., 612b. A solid curve represents results of example DE model performance 608. It is apparent from inspection that the example DE model performance 608 is relatively close to the first and second modes 604, 606 along the central region 612a, e.g., with x between about −2 and 2. However, the example DE model performance 608 follows neither of the first and second modes 604, 606 along the extreme regions, e.g., with values of x beknow −2 and above 2, as in region 612b.

The example DE performance graph 600 also includes upper and lower error bounds 610a, 610b. It is further apparent from the error bounds, that the DE model may track the first and second modes 604, 606 to at least some degree along the central region 612a but suffers from an extreme error bounds outside of this limited region. Accordingly, any predictions obtained from this model capture only a single mode that overestimates uncertainty. DEs cannot capture the multimodality of the noise, while MDNs and DGMEs can. Furthermore, DGMEs approximate the mixture weights of the noise accurately (ground truth: π₁=0.7 and π=0.3).

TABLE 3
Average NLL of test examples for regression experiments on real datasets.

| Dataset | MDNs | MCD | DEs | DGMEs (J = 1) | DGMEs (J = 2) | DGMEs (J = 5) | DGMEs (J = 10) |
|---|---|---|---|---|---|---|---|
| Boston housing | 2.62 ± 0.43 | 2.46 ± 0.25 | 2.41 ± 0.25 | 2.34 ± 0.19 | 2.33 ± 0.22 | 2.41 ± 0.25 | 2.46 ± 0.31 |
| Concrete | 3.11 ± 0.26 | 3.04 ± 0.09 | 3.06 ± 0.18 | 3.04 ± 0.11 | 3.00 ± 0.12 | 2.95 ± 0.13 | 2.94 ± 0.14 |
| Energy | 1.18 ± 0.30 | 1.99 ± 0.09 | 1.38 ± 0.22 | 1.71 ± 0.19 | 1.48 ± 0.15 | 1.20 ± 0.23 | 1.20 ± 0.40 |
| Kin8nm | −1.18 ± 0.04 | −0.95 ± 0.03 | −1.20 ± 0.02 | −1.20 ± 0.02 | −1.23 ± 0.03 | −1.24 ± 0.02 | −1.25 ± 0.02 |
| Power plant | 2.81 ± 0.04 | 2.80 ± 0.05 | 2.79 ± 0.04 | 2.82 ± 0.03 | 2.81 ± 0.03 | 2.81 ± 0.03 | 2.79 ± 0.03 |
| Wine | 1.01 ± 0.10 | 0.93 ± 0.06 | 0.94 ± 0.12 | 0.95 ± 0.11 | 0.96 ± 0.11 | 0.96 ± 0.12 | 1.10 ± 0.09 |
| Yacht | 1.18 ± 0.17 | 1.55 ± 0.12 | 1.18 ± 0.21 | 1.07 ± 0.22 | 0.75 ± 0.22 | 0.60 ± 0.29 | 0.49 ± 0.29 |

FIG. 6B is a deep Gaussian mixture ensemble (DGME) performance graph 650 providing another example predictive distribution plots for a bimodal Gaussian toy regression example in accordance with various aspects described herein. The first and second curves represent grounded truth for first and second modes 624, 626. A first solid curve represents results of example DGME model performance 618. It is apparent from inspection that the example DGME model performance 618 is relatively close to the first mode 624 along the entire span, at least with respect to values of x between about −4 and 4. The example DGME performance graph 650 also includes upper and lower error bounds 620a, 620b. It is further apparent from the error bounds, that the DGME model may track both of the first and second mode 624, 626 fairly well along the entire range of x values. Likewise, a second solid curve represents results of example DGME model performance 628. It is apparent from inspection that the example DGME model performance 628 is relatively close to the second mode 626, once again, along the entire span, at least with respect to values of x between about −4 and 4. The example DGME performance graph 650 also includes upper and lower error bounds 630a, 630b. It is further apparent from the error bounds, that the DGME model may track the second mode 626 fairly well along the entire range of x values. Accordingly, any predictions obtained from this model capture the bi-modal characteristic allowing the DGME model to predict both modes with a well calibrated uncertainty.

DGMEs obtain competitive or better performance in terms of NLL on a majority of datasets as compared to the baselines.

A second evaluation case relates to heavy-tailed noise, in which a value pᵤ=0 is set to zero and it may be assumed that the noise distributed according to a zero-mean Student-t distribution with ν=3 degrees of freedom with variance of 9. FIG. 1 shows the histogram of samples from the predictive distribution of both a training and a test input with their corresponding sample (excess) kurtosis. It may be observed that on the training examples (i.e., purple histograms), only MDNs and DGMEs are able to learn the heavy-tailedness of the noise, as both MCD and DEs obtain a kurtosis close to 0. Unlike the baseline approaches, which are unable to learn the tail behavior in the test example, it may be observed that DGMEs is the best method at capturing the heavy-tailedness of the test examples, as it gives the largest corresponding kurtosis.

A third evaluation case relates to bimodal Gaussian noise, in which a value pᵤ=0.3 is set to 0.3 and it is assumed that the noise is zero-mean, and Gaussian distributed with variance of 9. For this example, only the mixture-based approaches are compared assuming K=2 components. FIG. 2 shows the predictive density for the corresponding 99% credible interval for each mixture in each approach, where for DGMEs the learned mixture weights of each component are also shown. It may be observed that only MDNs and DGMEs are able to capture the bimodality of the data, with DGMEs also accurately capturing the mixture weight proportions. DEs instead overestimates the heteroscedastic variance in each network. This is due to the fact that DEs train each ensemble member independently under the assumption of Gaussian likelihood. It may also be shown that DGMEs can robustly estimate this bimodality, even if the assumed number of mixture components is larger than 2.

What has been described above includes mere examples of various embodiments. It is, of course, not possible to describe every conceivable combination of components or methodologies for purposes of describing these examples, but one of ordinary skill in the art can recognize that many further combinations and permutations of the present embodiments are possible. Accordingly, the embodiments disclosed and/or claimed herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

The DGME techniques disclosed herein provide examples of novel probabilistic DL ensemble method for jointly quantifying epistemic and aleatoric uncertainty. Unlike deep ensembling, DGMEs optimizes the data likelihood directly and is able to capture complex behavior in the predictive distribution (e.g., heavy-tailedness and multimodality) by modeling the conditional distribution of the data as a Gaussian mixture. Experiments have shown that DGMEs can capture more complex distributional properties than a variety of probabilistic DL baselines in regression settings and obtain competitive performance on detecting OOD samples in classification settings. As next steps, alternative mechanisms for handling the epistemic uncertainty can be considered. For example, one can instead form a variational approximation to the posterior of each mixture component, thereby forming a Gaussian mixture approximation to the posterior parameters of the ensemble. Additionally, a more thorough analysis of the classification setting can be considered. Rather than using a mixture of categorical distributions to model the predictive density, one can use a mixture of Dirichlet distributions to account for uncertainty in the class probabilities. Finally, DGMEs can be applied to improve the efficiency of active learning algorithms and exploration strategies in reinforcement learning.

The performance of DGMEs may be evaluated in regression against other techniques, such as the MDNs, MCD and DE techniques discussed herein, on a set of UCI regression benchmark datasets. An experimental setup was used in which each dataset was split into 20 train-test folds. The same network architecture was used across each dataset: an MLP with a single hidden layer and ReLU activations, containing 50 hidden units. Training for each data set was implemented for E=40 total epochs with a batch size of 32 and a learning rate of η=0.001. To be consistent with previous evaluations, a value of K=5 networks was used in the ensemble with results for DGMEs provided for different numbers of EM steps, e.g., J∈{1,2,5,10}. The results are shown in Tables 2 and 3, in which a root-mean-squared error (RMSE) and negative log-likelihood (NLL) were evaluated on a test set averaged over different folds, respectively. In the same table, the results for MDNs, MCD and DEs are also reported. It is worth noting that in this experiment, dropouts were not applied to MDNs and DGMEs and only account for uncertainty obtained from training the models to maximize the NLL of the samples according to the Gaussian mixture assumption.

TABLE 4
Average RMSE of the test examples for the financial forecasting experiment.
Test RMSE

| Dataset | MDNs | MCD | DEs | MultiSWAG | DGMEs |
|---|---|---|---|---|---|
| GOOG | 2.74 ± 0.06 | 3.86 ± 0.16 | 2.73 ± 0.03 | 2.71 ± 0.05 | 2.71 ± 0.04 |
| RCL | 15.01 ± 4.71 | 16.19 ± 10.18 | 14.92 ± 1.44 | 11.73 ± 0.45 | 14.49 ± 2.73 |
| GME | 11.14 ± 7.75 | 2.70 ± 0.47 | 3.21 ± 0.46 | 2.00 ± 0.06 | 3.19 ± 0.33 |

It was observed during experimentation that DGMEs are able to obtain competitive, or even better, performance with respect to the other example baseline methods. For certain datasets, it was determined that increasing a number of EM steps substantially improves the performance, e.g., concrete, energy, power plant, and yacht. It is understood, however, that this may not be generally true for all datasets. For example, for the Boston housing dataset, it was observed that increasing a number of EM steps begins to degrade the performance of the model in terms of NLL. It is understood that performance may be further improved by incorporating dropouts in the training procedure, in which a dropout probability pa may be selected using cross-validation on each train-test split.

Other experiments were conducted to focus on a task of “one-step-ahead” forecasting, e.g., as may be useful in applications relating to a financial time series. For example, a historical daily price data from Yahoo finance may be used to formulate a one-step ahead forecasting problem using a long short-term memory (LSTM) network. The input to the network includes a time series that represents a closing price of a particular stock over some previous time period, e.g., over the past 30 trading days. The target output may be identified as the next trading day's closing price. Performance of the model may be assessed using at least two metrics: (1) the NLL of the test set, and (2) the RMSE score on the test set. Each method was evaluated on three different datasets.

A first data set relates to a stable market regime, in which training data was obtained from Google (GOOG) stock over a training sample period of January 2019 through July 2022 and test data was obtained from GOOG stock data over a testing sample period of August 2022 through January 2023.

A second data set relates to market shock regime, in which training data was obtained from the Royal Caribbean (RCL) stock over a training sample period of January 2019 through April 2020 and test data was obtained from RCL stock data over a testing sample period of May 2020 through September 2020.

A third data set relates to a high volatility regime, in which training data was obtained from Gamestop (GME) stock during a “bubble” period over a training sample period of November 2020 through January 2022 and test data was obtained from GME stock data over a testing sample period following that period.

Each of the previously tested baselines were run along with DGMEs on the three scenarios previously described. Additionally, a MultiSWAG approach was tested, due to its effectiveness in quantifying epistemic uncertainty, which is of particular importance for the market shock regime. Each model was trained on each dataset for 5 independent runs, with the resulting mean and standard error of both the test NLL and the test RMSE provided in Tables 4 and 5. The best performing method in each experiment has been bolded according to the mean value of the metric.

The results indicate that for the GOOG dataset, DGMEs achieve, on average, the best NLL and RMSE score. In the case of the RCL dataset, an interesting result was observed. Namely, the DGMEs attain the best performance in terms of NLL, but MultiSWAG does best in terms of RMSE. It is understood that DGMEs outperform in terms of NLL according to the likelihood function assumed by DGMEs being a true Gaussian mixture, while the MultiSWAG approach applied a stochastic weight averaging Gaussian (SWAG) independently on multiple networks under a Gaussian likelihood assumption. This offers DGMEs an advantage in terms of learning the complex nature of the RCL dataset. On the other hand, it has been observed that, since MultiSWAG is accounting for uncertainty using SWAG, it appears to make model training more stable, hence the smaller standard error on each of the metrics, and better accounts for epistemic uncertainty. This could possibly explain why the RMSE score is lower than that of DGMEs and with smaller standard error. For the GME dataset, MultiSWAG outperforms DGMEs consistently, and with tighter standard error bars. The disclosed DGME techniques have accounted for epistemic uncertainty in DGMEs using dropout. It is understood that other approaches may be used, such as variational inference, Laplace approximation, or SWAG. Based on the experimental results, it would appear that an application of SWAG in the training of DGMEs as opposed to dropout may account for epistemic uncertainty.

TABLE 5
Average NLL of the test examples for the financial forecasting experiment.
Test NLL

| Dataset | MDNs | MCD | DEs | MultiSWAG | DGMEs |
|---|---|---|---|---|---|
| GOOG | 2.46 ± 0.03 | 2.98 ± 0.01 | 2.44 ± 0.01 | 2.54 ± 0.00 | 2.43 ± 0.02 |
| RCL | 18.83 ± 17.82 | 6.12 ± 3.93 | 5.94 ± 0.80 | 6.21 ± 0.18 | 5.00 ± 0.76 |
| GMB | 6.01 ± 3.85 | 2.46 ± 0.16 | 2.66 ± 0.13 | 2.14 ± 0.08 | 2.61 ± 0.31 |

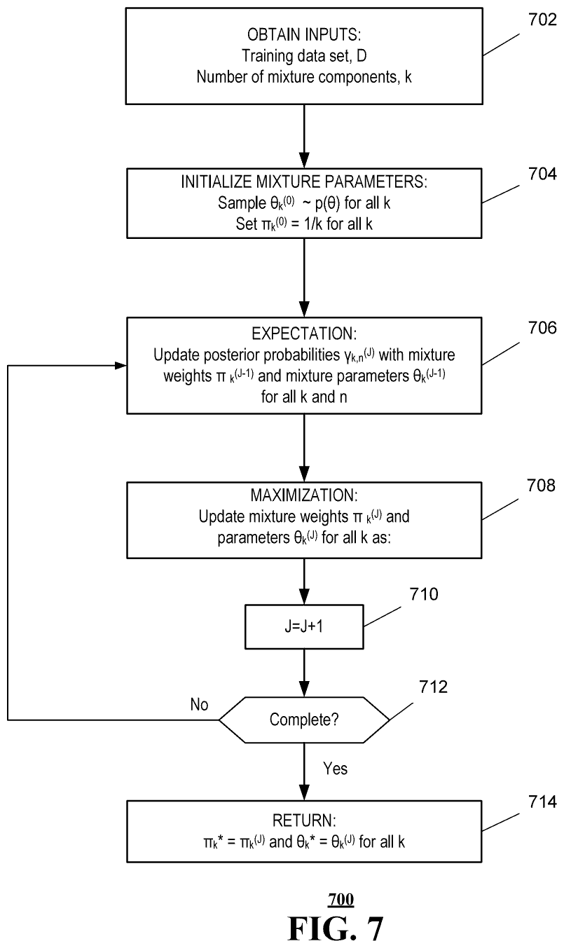

FIG. 7 depicts an illustrative embodiment of a deep-Gaussian-mixture ensemble (DGME) process 700 in accordance with various aspects described herein. According to the example DGME process 700, input data is obtained at 702. Input data may include, without limitation, a set of training data set D={(xₙ,yₙ)} [symbol] . Alternatively, or in addition, the input data may include a number of mixture components, k, to be included in the ensemble. It is understood that the number of mixing components may be predetermined, e.g., according to a class of problems for which a solution is sought using the DGME techniques. In at least some embodiments, the number of mixing components, k, may be determined, at least in part, according to condition, such as a processing capacity available for implementation of the DGME techniques, a processing time, e.g., a maximum processing time, a size and/or complexity of the training data set, D, according to prior applications of the DGME technique to another data set, D′, and/or another application. In at least some embodiments, the number of mixing components, k, may be varied, e.g., incrementally from some minimum value, kₘᵢₙ, to some maximum value or upper limit, kₘₐₓ.

By way of example, it is understood that in at least some embodiments, different values of k may be selected and the entire process 700 repeated to obtain a set of trained DGME models according to the different values of k. In a subsequent process, the trained DGME models may be further evaluated to determine a preferred value of k′ from among the various values examined. The preferred number of mixing components may be determined according to one or more comparisons of DBME performance, training complexity, training time, DGME model precision, e.g., as may be determined with testing data, and so on.

The training data set includes a collection of N features, xₙ, with n=1, . . . , N and an associated collection of N output values yₙ, with n=1, . . . , N. It is understood that in at least some embodiments, each feature may include some number of feature elements, e.g., x_{n,i}, with i=1, . . . ,m, such that the feature may be represented as a feature vector xₙ. Likewise, it is understood that in at least some embodiments, each output value may include some number of output value elements, e.g., y_{n,i}, with i=1, . . . ,p, such that the output value may be represented as an output value vector yₙ. It is understood further that the output values yₙ may be real-valued for applications of the DGME technique dealing with a regression task or integer-valued for applications of the DGME technique dealing with a classification task.

According to the example process 700, one or more mixture parameters are initialized at 704. Mixture parameters may include, without limitation, a set of k mixture weights πₖ, in which the weight πₖ denotes a weight of the k-th mixture component. Alternatively, or in addition, mixture parameters may include a set of underlying model parameters θₖ, in which θₖ denotes underlying model parameters θₖ the k-th mixture component. The numbers of mixture weights and model parameters are determined according to the initialized number of mixture components k. It is underlying model parameters θₖ may depend upon the types of distributions of the mixture components. For example, DGME utilizes mixture components according to Gaussian distributions. Accordingly, for DGME applications, the underlying model parameters Ok may include parameters of functions μ_{θ}_{ₖ}(⋅) and σ_{θ}_{ₖ}² that output mean and variance values of the k-th mixture components.

In at least some embodiments, the underlying model parameters θₖ may be initialized according to p(θ) for all values of k. Alternatively, or in addition, the mixture weights πₖ may be initialized to 1/k for all values of k.

Further according to the example process 700, an expectation process may be applied at 706, according to mixture weights πₖ^{(j)} and underlying model parameters θₖ^{(j)}. It is understood that the values mixture weights πₖ^{(j)} and underlying model parameters θₖ^{(j)}, may be updated at each iteration step, e.g., according to an incremented variable, j. For example, the expectation process may update posterior probabilities γ_{k,n}^{(j)} with mixture weights and mixture parameters with mixture weights πₖ^{(j-1)} and underlying model parameters θₖ^{(j-1)}, for all values of k and n.

Further according to the example process 700, a maximization process may be applied at 708, according to update the mixture weights πₖ^{(j)} and underlying model parameters θₖ^{(j)} for all values of k. Mathematically, this may be represented as:

$${π}_{k}^{( j )} = \frac{1}{N} {\sum }_{n = 1}^{N} {γ}_{k , n}^{( j )} , \\ and$$

$${θ}_{k}^{( j )} = {arg max}_{{θ}_{k} ∈ {Θ}_{k}} {\sum }_{n = 1}^{N} {γ}_{k , n}^{( j )} {ℓ}_{{θ}_{k}} ( {x}_{n} , {y}_{n} )$$

The index variable j may be incremented at 710 and a determination made at 712 as to whether the expectation and maximization steps should be repeated. In at least some embodiments, the determination as to whether the expectation and maximization steps should be repeated is based on the index variable. For example, the incremented value compared to a maximum number of iterations. Alternatively, or in addition, the determination as to whether the expectation and maximization steps should be repeated is based on a condition and/or event. For example, a condition may be based on a maximum processing time, a rate of change of some value, e.g., an incremental change or delta value for one or more of the mixture weights πₖ^{(j)} and underlying model parameters θₖ^{(j)}.

To the extent it is determined at 712 that the expectation and maximization steps should be repeated, the process 700 returns to reperform the expectation step at 706 and the maximization step at 708, using the updated values of the mixture weights πₖ^{(j)} and underlying model parameters θₖ^{(j)}. Alternatively, to the extent that it has been determined at 710 that repetition of the expectation and maximization steps is no longer necessary, solution values of π* and θ* may be returned at 714. For example, the solution values π* and θ* may be based on current values of the mixture weights πₖ^{(j)} and underlying model parameters θₖ^{(j)}, e.g., π*=πₖ^{(j)} and θ*=θₖ^{(j)}.

While for purposes of simplicity of explanation, the respective processes are shown and described as a series of blocks in FIG. 7, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

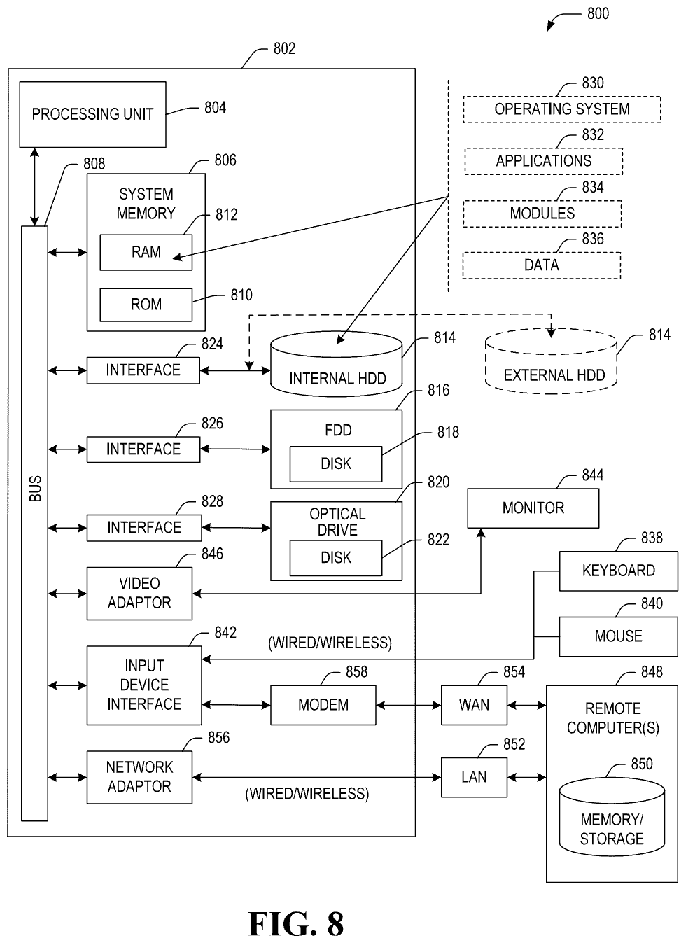

Turning now to FIG. 8, there is illustrated a block diagram of an example, non-limiting embodiment of a computing environment 800 in accordance with various aspects described herein. In order to provide additional context for various embodiments of the embodiments described herein, FIG. 8 and the following discussion are intended to provide a brief, general description of a suitable computing environment 800 in which the various embodiments of the subject disclosure can be implemented. For example, computing environment 800 can facilitate, in whole or in part, identifying a number of mixture components of a mixture ensemble of an artificial neural network by determining sets of mixture weights mixture parameters of the mixture ensemble. A set of posterior probabilities may be calculated according to the sets of mixture weights and mixture parameters, and the sets of mixture weights and mixture parameters revised according to an optimization process according to the set of posterior probabilities. A revised set of mixture weights is determined according to a sum of the set of posterior probabilities and a revised set of mixture parameters determined according to a solution of a numerical optimization.

Generally, program modules comprise routines, programs, components, data structures, etc., that perform particular tasks or implement particular abstract data types. Moreover, those skilled in the art will appreciate that the methods can be practiced with other computer system configurations, comprising single-processor or multiprocessor computer systems, minicomputers, mainframe computers, as well as personal computers, hand-held computing devices, microprocessor-based or programmable consumer electronics, and the like, each of which can be operatively coupled to one or more associated devices.

As used herein, a processing circuit includes one or more processors as well as other application specific circuits such as an application specific integrated circuit, digital logic circuit, state machine, programmable gate array or other circuit that processes input signals or data and that produces output signals or data in response thereto. It should be noted that while any functions and features described herein in association with the operation of a processor could likewise be performed by a processing circuit.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data or unstructured data.

Computer-readable storage media can comprise, but are not limited to, random access memory (RAM), read only memory (ROM), electrically erasable programmable read only memory (EEPROM), flash memory or other memory technology, compact disk read only memory (CD ROM), digital versatile disk (DVD) or other optical disk storage, magnetic cassettes, magnetic tape, magnetic disk storage or other magnetic storage devices or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and comprises any information delivery or transport media. The term “modulated data signal” or signals refers to a signal that has one or more of its characteristics set or changed in such a manner as to encode information in one or more signals. By way of example, and not limitation, communication media comprise wired media, such as a wired network or direct-wired connection, and wireless media such as acoustic, RF, infrared and other wireless media.

With reference again to FIG. 8, the example environment can comprise a computer 802, the computer 802 comprising a processing unit 804, a system memory 806 and a system bus 808. The system bus 808 couples system components including, but not limited to, the system memory 806 to the processing unit 804. The processing unit 804 can be any of various commercially available processors. Dual microprocessors and other multiprocessor architectures can also be employed as the processing unit 804.

The system bus 808 can be any of several types of bus structure that can further interconnect to a memory bus (with or without a memory controller), a peripheral bus, and a local bus using any of a variety of commercially available bus architectures. The system memory 806 comprises ROM 810 and RAM 812. A basic input/output system (BIOS) can be stored in a non-volatile memory such as ROM, erasable programmable read only memory (EPROM), EEPROM, which BIOS contains the basic routines that help to transfer information between elements within the computer 802, such as during startup. The RAM 812 can also comprise a high-speed RAM such as static RAM for caching data.

The computer 802 further comprises an internal hard disk drive (HDD) 814 (e.g., EIDE, SATA), which internal HDD 814 can also be configured for external use in a suitable chassis (not shown), a magnetic floppy disk drive (FDD) 816, (e.g., to read from or write to a removable diskette 818) and an optical disk drive 820, (e.g., reading a CD-ROM disk 822 or, to read from or write to other high-capacity optical media such as the DVD). The HDD 814, magnetic FDD 816 and optical disk drive 820 can be connected to the system bus 808 by a hard disk drive interface 824, a magnetic disk drive interface 826 and an optical drive interface 828, respectively. The hard disk drive interface 824 for external drive implementations comprises at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 802, the drives and storage media accommodate the storage of any data in a suitable digital format. Although the description of computer-readable storage media above refers to a hard disk drive (HDD), a removable magnetic diskette, and a removable optical media such as a CD or DVD, it should be appreciated by those skilled in the art that other types of storage media which are readable by a computer, such as zip drives, magnetic cassettes, flash memory cards, cartridges, and the like, can also be used in the example operating environment, and further, that any such storage media can contain computer-executable instructions for performing the methods described herein.

A number of program modules can be stored in the drives and RAM 812, comprising an operating system 830, one or more application programs 832, other program modules 834 and program data 836. All or portions of the operating system, applications, modules, and/or data can also be cached in the RAM 812. The systems and methods described herein can be implemented utilizing various commercially available operating systems or combinations of operating systems.

A user can enter commands and information into the computer 802 through one or more wired/wireless input devices, e.g., a keyboard 838 and a pointing device, such as a mouse 840. Other input devices (not shown) can comprise a microphone, an infrared (IR) remote control, a joystick, a game pad, a stylus pen, touch screen or the like. These and other input devices are often connected to the processing unit 804 through an input device interface 842 that can be coupled to the system bus 808, but can be connected by other interfaces, such as a parallel port, an IEEE 1394 serial port, a game port, a universal serial bus (USB) port, an IR interface, etc.

A monitor 844 or other type of display device can be also connected to the system bus 808 via an interface, such as a video adapter 846. It will also be appreciated that in alternative embodiments, a monitor 844 can also be any display device (e.g., another computer having a display, a smart phone, a tablet computer, etc.) for receiving display information associated with computer 802 via any communication means, including via the Internet and cloud-based networks. In addition to the monitor 844, a computer typically comprises other peripheral output devices (not shown), such as speakers, printers, etc.

The computer 802 can operate in a networked environment using logical connections via wired and/or wireless communications to one or more remote computers, such as a remote computer(s) 848. The remote computer(s) 848 can be a workstation, a server computer, a router, a personal computer, portable computer, microprocessor-based entertainment appliance, a peer device or other common network node, and typically comprises many or all of the elements described relative to the computer 802, although, for purposes of brevity, only a remote memory/storage device 850 is illustrated. The logical connections depicted comprise wired/wireless connectivity to a local area network (LAN) 852 and/or larger networks, e.g., a wide area network (WAN) 854. Such LAN and WAN networking environments are commonplace in offices and companies, and facilitate enterprise-wide computer networks, such as intranets, all of which can connect to a global communications network, e.g., the Internet.

When used in a LAN networking environment, the computer 802 can be connected to the LAN 852 through a wired and/or wireless communication network interface or adapter 856. The adapter 856 can facilitate wired or wireless communication to the LAN 852, which can also comprise a wireless AP disposed thereon for communicating with the adapter 856.

When used in a WAN networking environment, the computer 802 can comprise a modem 858 or can be connected to a communications server on the WAN 854 or has other means for establishing communications over the WAN 854, such as by way of the Internet. The modem 858, which can be internal or external and a wired or wireless device, can be connected to the system bus 808 via the input device interface 842. In a networked environment, program modules depicted relative to the computer 802 or portions thereof, can be stored in the remote memory/storage device 850. It will be appreciated that the network connections shown are examples and other means of establishing a communications link between the computers can be used.

The computer 802 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This can comprise Wireless Fidelity (Wi-Fi) and BLUETOOTH® wireless technologies. Thus, the communication can be a predefined structure as with a conventional network or simply an ad hoc communication between at least two devices.

Wi-Fi can allow connection to the Internet from a couch at home, a bed in a hotel room or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, n, ac, ag, etc.) to provide secure, reliable, fast wireless connectivity. A Wi-Fi network can be used to connect computers to each other, to the Internet, and to wired networks (which can use IEEE 802.3 or Ethernet). Wi-Fi networks operate in the unlicensed 2.4 and 5 GHz radio bands for example or with products that contain both bands (dual band), so the networks can provide real-world performance similar to the basic 10BaseT wired Ethernet networks used in many offices.

Although the various techniques disclosed herein refer to normal or Gaussian mixture ensembles, it is understood that other distributions may be utilized in a similar manner, e.g., determining mixture weights and mixture parameters. To the extent other distributions are used, it is understood that the parameters of mean and standard deviation referred to herein, may be changed and/or extended to include other parameters as may be relevant to other distributions. It is also understood that although the various examples disclosed herein refer to mixture parameters are determined according to parameters of an artificial neural network, such as weights and biases, it is understood that the same or similar approach may be applied to other parameters, such as hyperparameters, e.g., a number of nodes, interconnections between nodes, activation functions, and so on.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data or unstructured data. Computer-readable storage media can comprise the widest variety of storage media including tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

As may also be used herein, the term(s) “operably coupled to”, “coupled to”, and/or “coupling” includes direct coupling between items and/or indirect coupling between items via one or more intervening items. Such items and intervening items include, but are not limited to, junctions, communication paths, components, circuit elements, circuits, functional blocks, and/or devices. As an example of indirect coupling, a signal conveyed from a first item to a second item may be modified by one or more intervening items by modifying the form, nature or format of information in a signal, while one or more elements of the information in the signal are nevertheless conveyed in a manner than can be recognized by the second item. In a further example of indirect coupling, an action in a first item can cause a reaction on the second item, as a result of actions and/or reactions in one or more intervening items.

Although specific embodiments have been illustrated and described herein, it should be appreciated that any arrangement which achieves the same or similar purpose may be substituted for the embodiments described or shown by the subject disclosure. The subject disclosure is intended to cover any and all adaptations or variations of various embodiments. Combinations of the above embodiments, and other embodiments not specifically described herein, can be used in the subject disclosure. For instance, one or more features from one or more embodiments can be combined with one or more features of one or more other embodiments. In one or more embodiments, features that are positively recited can also be negatively recited and excluded from the embodiment with or without replacement by another structural and/or functional feature. The steps or functions described with respect to the embodiments of the subject disclosure can be performed in any order. The steps or functions described with respect to the embodiments of the subject disclosure can be performed alone or in combination with other steps or functions of the subject disclosure, as well as from other embodiments or from other steps that have not been described in the subject disclosure. Further, more than or less than all of the features described with respect to an embodiment can also be utilized.

Supporting material. The following disclosure includes additional details and support related to the various devices, processes and techniques disclosed above.

### A. Theoretical Proofs.

Proposition A.1. Under the assumption that πᵢ=1/K−1 for i=1, . . . ,K, maximizing the Gaussian mixture data likelihood directly achieves better or equal joint likelihood than maximizing each ensemble member's likelihood separately.

The EM algorithm minimizes the joint data log-likelihood as defined in equation (5), which can be lower-bounded in the following way by using Jensen's inequality:

$$\begin{matrix}{𝔼}_{X , Y} [ log ( {\sum }_{k = 1}^{K} {π}_{k} {p}_{k} ( y \vert x , {θ}_{k} ) ) ] \geq {arg max}_{θ} {𝔼}_{X , Y} [ log {\sum }_{k = 1}^{K} log ( {π}_{k} ) + log ( {p}_{k} ( y \vert x , {θ}_{k} ) ) ] = \\ = {arg max}_{θ} {\sum }_{k = 1}^{K} {𝔼}_{X , Y} [ log ( {π}_{k} ) ] + {𝔼}_{X , Y} [ {ℓ}_{{θ}_{k}} ( x , y ) ) ] .\end{matrix}$$

By assumption, the first term constant (of value −log(K)), hence:

$${arg max}_{θ} {𝔼}_{X , Y} [ log ( {\sum }_{k = 1}^{K} {π}_{k} {p}_{k} ( y \vert x , {θ}_{k} ) ) ] \geq {arg max}_{θ} {\sum }_{k = 1}^{K} {𝔼}_{X , Y} [ {ℓ}_{{θ}_{k}} ( x , y ) ) ] ,$$

with the lower bound corresponding to maximizing the likelihood of each ensemble member separately, as performed in DEs.

Proposition A.2. Under assumptions noted above, let the mean and variance in each ensemble model being estimated via a separate 2-layer deep ReLU network from a common feature extraction layer. Then the DGMEs EM algorithm convergences to a non-stationary point that maximizes the data likelihood with high probability.

To guarantee convergence of the EM algorithm it is enough to prove that at every round t:

$$∀ θ / ∈ N : Q ( θ ( t + 1 ) ; θ ( t ) ) - Q ( θ ( t ) ; θ ( t ) ) > 0 , \qquad ( 19 )$$

in which N is the set of stationary points of the function Q. By writing the difference in equation (19) above it is given that:

$$\begin{matrix}Q ( {θ}^{( t + 1 )} ; {θ}^{( t )} ) - Q ( {θ}^{( t )} ; {θ}^{( t )} ) = {\sum }_{n = 1}^{N} {\sum }_{k = 1}^{K} {γ}_{k , n} ( log ( {π}_{k} ) + {ℓ}_{{θ}^{( t + 1 )}} ( {x}_{n} , {y}_{n} ) ) - {\sum }_{n = 1}^{N} {\sum }_{k = 1}^{K} {γ}_{k , n} ( log ( {π}_{k} ) + {ℓ}_{{θ}^{( t )}} ( {x}_{n} , {y}_{n} ) ) \\ = {\sum }_{k = 1}^{K} [ {\sum }_{n = 1}^{N} {γ}_{k , n} ( {ℓ}_{{θ}^{( t + 1 )}} ( {x}_{n} , {y}_{n} ) ) - {\sum }_{n = 1}^{N} {γ}_{k , n} ( {ℓ}_{{θ}^{( t )}} ( {x}_{n} , {y}_{n} ) ) ]\end{matrix} .$$

By setting θ^{(t+1)}=θₖ* and using Assumption 4.4:

$$Q ( {θ}_{k}^{*} ; {θ}^{( t )} ) - Q ( {θ}^{( t )} ; {θ}^{( t )} ) \geq {\sum }_{k = 1}^{K} \frac{{ϵ}_{t , k}}{K} > ϵ$$

The result follows if every ensemble network can learn the maximum likelihood θ* at every round. It can be shown that the above happens in high probability. Without loss of generality, set the round t and the ensemble member k if the mean and variance functions follow assumptions 4.5 and 4.6. Let [symbol] *= [symbol] _{θk*} and [symbol] \hat{ }_{θ} be the estimated likelihood. As the likelihood is Gaussian, the estimation problem is equivalent to estimating the true mean function μ*(x) and variance function σ*(x). Assume the mean and variance functions are learnt independently by using a pre-trained feature extraction layer, the estimation problem can be broken down into:

$${‖ ℓ ( {μ}^{*} , {σ}^{*} ) - ℓ ( \hat{μ} , \hat{σ} ) ‖}_{2} = {‖ ℓ ( {μ}^{*} , {σ}^{*} ) \pm ℓ ( {μ}^{*} , \hat{σ} ) - ℓ ( \hat{μ} , \hat{σ} ) ‖}_{2} \leq {\underbrace{{‖ ℓ ( {μ}^{*} , \hat{σ} ) - ℓ ( \hat{μ} , \hat{σ} ) ‖}_{2}}}_{( A )} + {\underbrace{{‖ ℓ ( {μ}^{*} , {σ}^{*} ) - ℓ ( {μ}^{*} , \hat{σ} ) ‖}_{2}}}_{( B )} .$$

Provided n>O(log (1/δ)/ϵ²) and using Assumption 4.7 to guarantee non-degenerate weights, the proposition follows since:
(A) For the mean function estimation, the likelihood reduces to a weighted least square loss. Hence, one would need at least n>O(log (1/δ)/ϵ) samples to estimate the mean function within ϵ/2 radius and with probability 1−δ;
(B) For the variance function estimation, one would need at least n>O(log (1/δ)/ϵ2) samples to estimate the mean function within an ϵ/2 radius and with probability 1−δ.

Proposition A.3. If the weights of each ensemble members are initialized to 0 with fixed bias terms, a single EM step for DGMEs is equivalent to performing DEs.

If any ensemble members fₖ has all weights initialized to 0, then it follows that pₖ(yₙ|xₙ,θₖ)=a for some constant δ∈ [symbol] . In addition, μ_{θ}_{ₖ}(xₙ)=μ and σ_{θ}_{ₖ}²(xₙ) for any xₙ. Hence, in the expectation steps all posterior probabilities are equal to:

$${γ}_{k , n} = \frac{{p}_{k} ( {y}_{n} \vert {x}_{n} , {θ}_{k} ) {P}_{θ} ( {z}_{n} = k )}{{\sum }_{j = 1}^{K} {p}_{j} ( {y}_{n} \vert {x}_{n} , {θ}_{j} ) {P}_{θ} ( {z}_{n} = j )} = \frac{δ𝒩 ( {y}_{n} ; μ , {σ}^{2} )}{{\sum }_{j = 1}^{K} δ𝒩 ( {y}_{n} ; {μ}_{k} , {σ}^{2} )} = \frac{1}{K}$$

Hence, the maximization in the M-step is equal to:

$${θ}_{k}^{★} = {arg max}_{{θ}_{k} ∈ {Θ}_{k}} {\sum }_{n = 1}^{N} {γ}_{k , n} {ℓ}_{{θ}_{k}} ( {x}_{n} , {y}_{n} ) = {arg max}_{{θ}_{k} ∈ {Θ}_{k}} {\sum }_{n = 1}^{N} {ℓ}_{{θ}_{k}} ( {x}_{n} , {y}_{n} ) ,$$

which corresponds to maximizing the likelihood of each ensemble member separately.

### B. Additional Experimental Results and Ablation Studies

B.1. Toy Regression. In this subsection, additional experimental results and ablation studies are provided on the toy regression dataset that provide valuable insights on the role of each of the DGME hyperparameters.

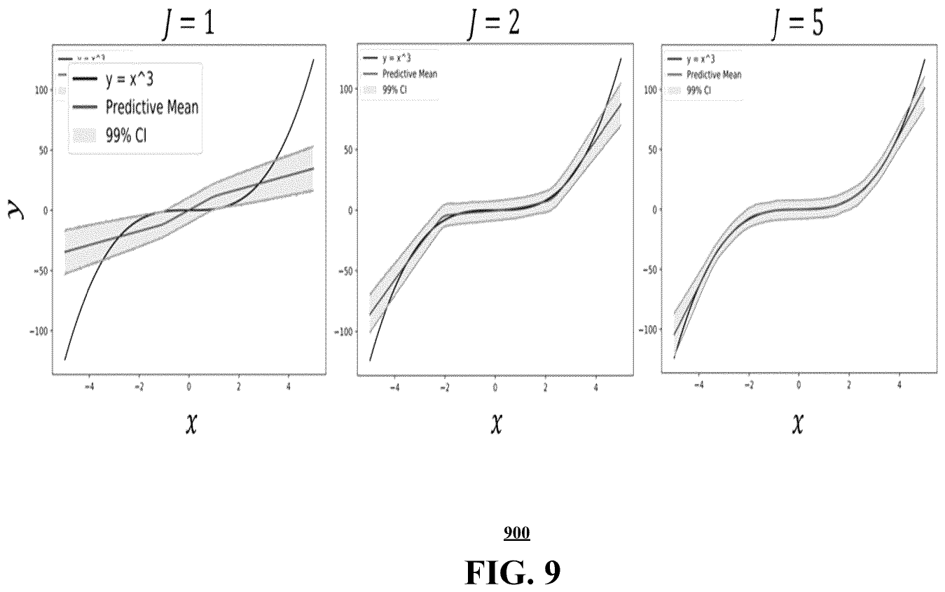

FIG. 9 provides a graph 900 of results on a toy regression task with Gaussian noise for different numbers of EM rounds. As J increases, the predictive mean improves.

TABLE 6
Training NLL obtained for the toy regression dataset using DGMEs under different configurations of the number
of epochs per EM round E and the total number of EM rounds J for a fixed computational budget E × J = 50.

| | (E = 1, J = 50) | (E = 2, J = 25) | (E = 5, J = 10) | (E = 10, J = 5) | (E = 25, J = 2) | (E = 50, J = 1) |
|---|---|---|---|---|---|---|
| Normal - Unimodal | 2.71 ± 0.06 | 2.63 ± 0.06 | 2.58 ± 0.03 | 2.54 ± 0.01 | 2.54 ± 0.01 | 2.56 ± 0.03 |
| Heavy-Tailed - Unimodal | 2.98 ± 0.03 | 2.95 ± 0.02 | 2.88 ± 0.02 | 2.87 ± 0.01 | 2.91 ± 0.01 | 2.96 ± 0.02 |
| Normal - Bimodal | 3.15 ± 0.05 | 3.09 ± 0.07 | 3.02 ± 0.04 | 3.13 ± 0.08 | 3.42 ± 0.06 | 3.53 ± 0.04 |

### B.1.1. Ablation: Number of EM Rounds.

To study the effect that the number of EM rounds has on training of DGMEs, FIG. 9 shows DGMEs trained with 1, 2 and 5 rounds on the toy regression task with Gaussian noise (Case 1), where the number of epochs per round is fixed to E=80. It can be seen in this figure that after J=5 EM rounds, the algorithm has converged to a conditional distribution that represents the ground truth quite well.

Additionally, the joint impact of the number of epochs E used in the M-Step per EM round and the total number of EM rounds J can be assessed, while keeping the total computational budget constant (e.g., E×J=50 total epochs). The following values of E∈{1,2,5,10,25,50} can be tested and report the average NLL over the training set and its corresponding standard error (computed over a total of 10 runs) in Table 6.

It can be seen empirically that for a fixed computational budget, there is tradeoff between the performance and the effective number of EM rounds. The tradeoff is more apparent when considering the more difficult examples (i.e., heavy-tailed unimodal noise and normal bimodal noise). If the number of epochs in the M-step is E=1 and a training for J=50 rounds, not enough information is being propagated between the E- and M-Step in each round of training, making learning inefficient. In the other extreme, if the number of epochs per M-step is E=50 and with a training for J=1 rounds, even if the optimization problem in the M-step is more accurately resolved, not enough EM rounds are run to accurately learn the underlying conditional density function. If the number of epochs per round and the total number of EM rounds are balanced, e.g., (E=5,J=10) or (E=10,J=5), a better performance is obtained in terms of training NLL.

### B.1.2. Ablation: Dropout and Adversarial Training.

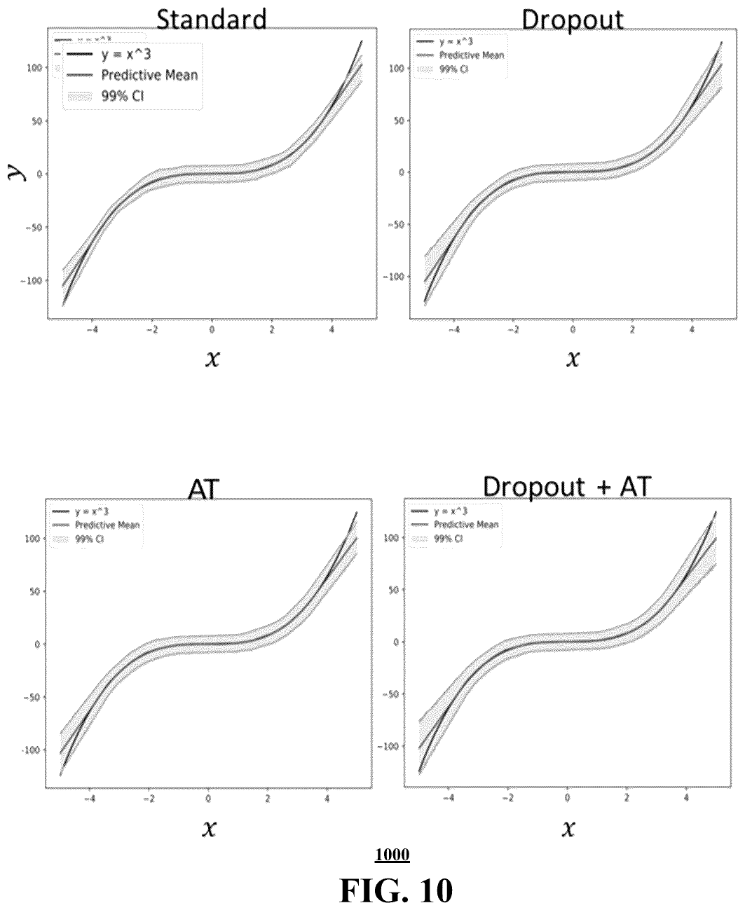

In this ablation, our goal is to understand the effect of epistemic uncertainty estimation techniques in DGMEs. As a rough analysis, FIG. 10 graphically illustrates the effect of training with dropout, adversarial training and their combination. Here, the dropout probability is set to pd=0.05. It can be seen that without dropout or adversarial training, the uncertainty estimates are well-calibrated for the training data, features taking value between −4 and 4, but are underestimated for the test data, features taking absolute value between 4 and 5. By incorporating dropout and adversarial training, it can be seen that the uncertainty estimates become larger for the test examples.

FIG. 10 provides a graph 1000 of results on a toy regression task with Gaussian noise. The leftmost plot corresponds to standard set up of DGMEs trained with K=5 networks. The second plot corresponds to incorporating Dropout in the training. The third plot shows the effect of using adversarial training, and final plot shows the effect of using both dropout and adversarial training.

TABLE 7
Train and test NLL of DGMEs for each toy regression dataset under different dropout probability values.

| | (E = 1, J = 50) | (E = 2, J = 25) | (E = 5, J = 10) | (E = 10, J = 5) | (E = 25. J = 2) | (E = 50, J = 1) |
|---|---|---|---|---|---|---|
| Normal - Unimodal | 2.71 ± 0.06 | 2.63 ± 0.06 | 2.58 ± 0.03 | 2.54 ± 0.01 | 2.54 ± 0.01 | 2.56 ± 0.03 |
| Heavy-Tailed - Unimodal | 2.98 ± 0.03 | 2.95 ± 0.02 | 2.88 ± 0.02 | 2.87 ± 0.01 | 2.91 ± 0.01 | 2.96 ± 0.02 |
| Normal - Bimodal | 3.15 ± 0.05 | 3.09 ± 0.07 | 3.02 ± 0.04 | 3.13 ± 0.08 | 3.42 ± 0.06 | 3.53 ± 0.04 |

To get a better understanding of the effect of dropout probability pd on the quantified uncertainty, the train and test NLL can be evaluated for different values of p_{d} for each of the toy datasets. Results are shown in Table 7. From this table, it is observed that dropout creates a trade-off between performance on in-sample data and out-of-sample data in terms of NLL. Increasing the dropout probability in this case causes the average NLL to be worse for the training set but improves it, up to a certain point, on the test set. In practice, the dropout probability can be chosen to minimize the NLL on a validation set.

### B.1.3. Ablation: Number of Mixture Components.

The number of components in the assumed Gaussian mixture impacts how well the model can estimate more complex noise distributions, e.g., heavy-tailed or bimodal distributions. Gaussian mixtures, with infinite components, are universal approximators to smooth continuous density functions, so the more components assumed, the more flexible the model is. When choosing the number of mixture components, one should take into consideration the complexity of the data generating process and the amount of data in the training set. If the data generating process is known to be Gaussian, then choosing a large number of components is not beneficial. On the other hand, if the data generating process is thought to be multimodal, then using more components is the better choice. This can be seen in the following two ablation studies.

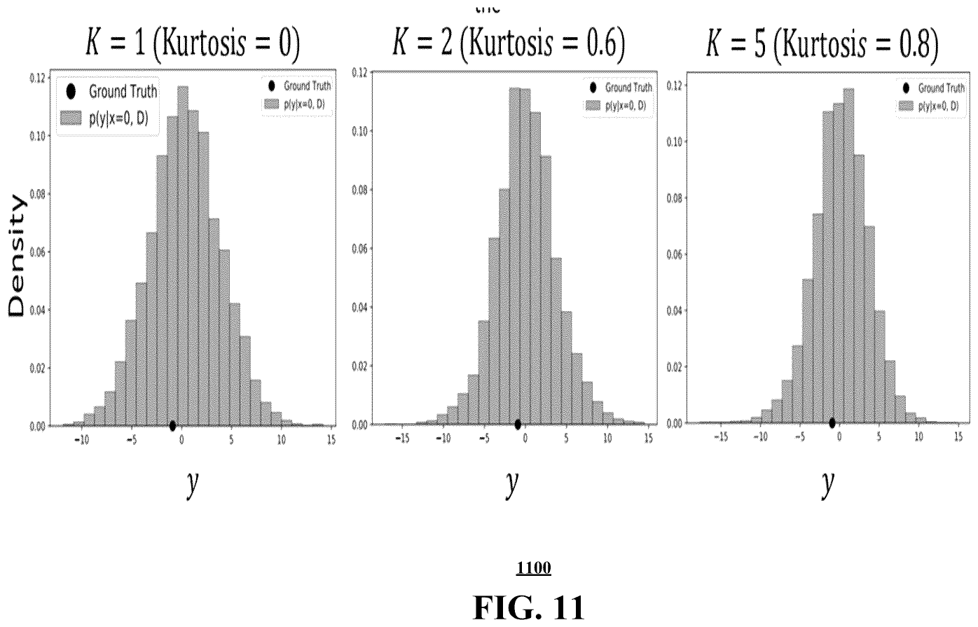

FIG. 11 provides a graph 1100 of an effect of a number of mixtures on a learned kurtosis of the predictive distribution under heavy-tailed noise. FIG. 11 shows the effect of the number of mixtures components K on the kurtosis of the learned predictive distribution. It can be observed that with more mixture components, the model learns a fatter-tailed distribution. This makes sense since a Student-t distribution can be viewed as a Gaussian mixture with an infinite number of components with different variances.

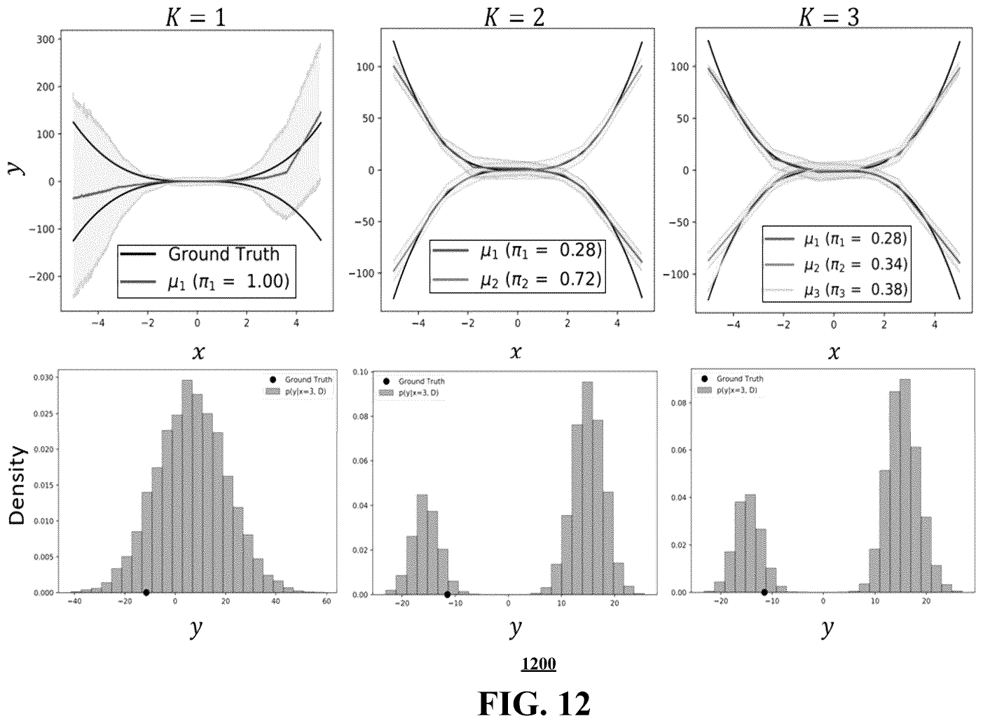

FIG. 12 provides a graph 1200 of an effect of the number of mixture components on the learned predictive distribution under bimodal noise. FIG. 12 shows the effect of the number of mixture components on the learned predictive distribution in the case of the bimodal Gaussian. It can be seen that when DGMEs assume only K=1 mixture component, DGMEs have a similar predictive distribution as DEs, since the model will attempt to explain the bimodal data with a single Gaussian by overestimating the aleatoric noise. An interesting insight is that when DGMEs assume too many components, e.g., K>2, the model is still able to accurately learn that the underlying predictive distribution is still bimodal.

### B.1.4. Ablation: Weight Initialization Schemes and Data Standardization.

To test the impact of weight initialization of the neural network on the performance of DGME, the following ablation study can be performed: a DGME is trained for 5 rounds, in which 10 epochs are used to resolve the M-Step in each round. The same architecture may be used as in the example toy experiments. The NLL on the training set can be evaluated under five different initializations: PyTorch default initialization, initialization with uniform distribution with bounds −0.01 to 0.01, initialization with normal distribution with mean 0 and standard deviation 10−6, uniform initialization, and normal initialization. As a note, the PyTorch default initialization for a linear layer is done via a uniform distribution u(−1/\sqrt{a},1/\sqrt{a}), in which a denotes the number of input features to the linear layer.

The model may be trained for each toy dataset over 20 total runs and report the average training NLL and its corresponding standard error. This ablation may be run twice: once for training with non-standardized data and once for training with standardized data. The results are shown in Table 8 and Table8. It can be seen from the results that although weight initialization has some impact on the results, if the data is standardized, it becomes less important. It can also be seen that across all datasets, the default PyTorch initialization gives the most favorable results for both non-standardized and standardized data.

TABLE 8
Impact of different weight initialization schemes
on the train NLL when the data is not standardized.

| | PyTorch | | | Xavier | Xavier |
|---|---|---|---|---|---|
| | Default | Uniform | Normal | Uniform | Uniform |
| Normal - Unimodal | 2.86 ± 0.07 | 3.08 ± 0.04 | 3.02 ± 0.04 | 2.88 ± 0.05 | 2.90 ± 0.05 |
| Heavy-Tailed - | 3.16 ± 0.05 | 3.42 ± 0.06 | 3.36 ± 0.05 | 3.18 ± 0.05 | 3.20 ± 0.05 |
| Unimodal | | | | | |
| Normal - Bimodal | 3.36 ± 0.17 | 3.56 ± 0.06 | 3.61 ± 0.06 | 3.46 ± 0.20 | 3.47 ± 0.20 |

TABLE 9
Impact of different weight initialization schemes
on the train NLL when the data is standardized.

| | PyTorch | | | Xavier | Xavier |
|---|---|---|---|---|---|
| | Default | Uniform | Normal | Uniform | Uniform |
| Normal - Unimodal | 2.55 ± 0.02 | 2.55 ± 0.01 | 2.56 ± 0.01 | 2.54 ± 0.01 | 2.53 ± 0.01 |
| Heavy-Tailed - | 2.87 ± 0.02 | 2.88 ± 0.01 | 2.88 ± 0.01 | 2.86 ± 0.01 | 2.87 ± 0.01 |
| Unimodal | | | | | |
| Normal - Bimodal | 3.13 ± 0.07 | 3.63 ± 0.01 | 3.60 ± 0.04 | 3.27 ± 0.09 | 3.24 ± 0.09 |

### B.1.5. Illustrative Results: Additive Gaussian Noise.

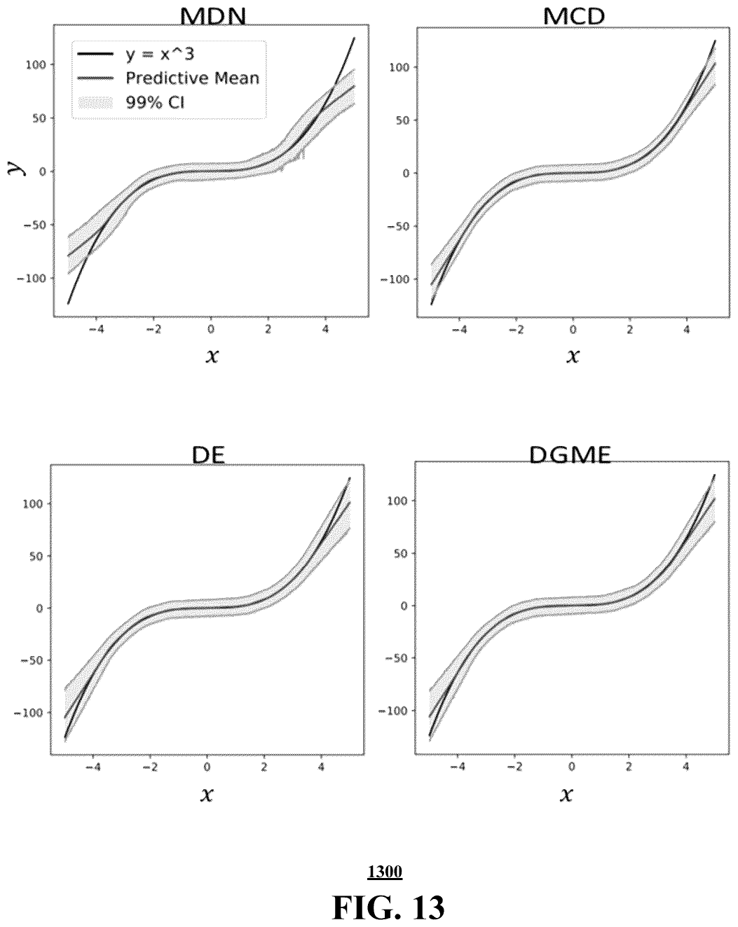

The DGME results may be compared with the baselines on the toy regression dataset with Gaussian noise. FIG. 13 provides a graph 1300 of performance on a toy regression task with Gaussian noise of DGMEs compared with performance of other state-of-the-art techniques, including MDNs, MCD and DEs. The DGMEs have comparable performance to MCD and DEs and outperform MDNs.

### B.2. Regression on Real Datasets

For real data experiments on a regression task, the following datasets may be used: (a) Boston Housing dataset, (b) Concrete compressive strength dataset, (c) Energy efficiency dataset, (d) Kinematics of an 8-link robot arm dataset, (e) Combined cycle power plant dataset, (f) Wine dataset and (g) Yacht hydrodynamics dataset.

As discussed above, to provide a fair comparison with techniques that assume the conditional distribution of the data is Gaussian, the mixture distribution output in both MDNs and DGMEs may be summarized into a single Gaussian and then evaluate the NLL. This is analogous to the way DEs compute the NLL. Additional results may also be provided for the test NLL under the assumption of a mixture of Gaussians in Table 10 below.

TABLE 10
Test NLL for the regression experiments in the mixture of Gaussians case.
TEST NLL (MIXTURE OF GAUSSIANS)

| Dataset | MDNs | MCD | DEs | DGMEs (J = 1) | DGMEs (J = 2) | DGMEs (J = 5) | DGMEs (J = 10) |
|---|---|---|---|---|---|---|---|
| Boston housing | 2.71 ± 0.45 | 2.46 ± 0.25 | 2.41 ± 0.25 | 2.33 ± 0.18 | 2.33 ± 0.23 | 2.51 ± 0.33 | 2.74 ± 0.53 |
| Concrete | 3.04 ± 0.22 | 3.04 ± 0.09 | 3.06 ± 0.18 | 3.03 ± 0.10 | 2.99 ± 0.14 | 2.97 ± 0.24 | 2.94 ± 0.22 |
| Energy | 0.70 ± 0.17 | 1.99 ± 0.09 | 1.38 ± 0.22 | 1.56 ± 0.14 | 1.31 ± 0.12 | 0.96 ± 0.20 | 0.92 ± 0.48 |
| Kin8nm | −1.17 ± 0.04 | −0.95 ± 0.03 | −1.20 ± 0.02 | −1.20 ± 0.02 | −1.23 ± 0.03 | −1.24 ± 0.02 | −1.24 ± 0.02 |
| Power plant | 2.74 ± 0.04 | 2.80 ± 0.05 | 2.79 ± 0.04 | 2.81 ± 0.03 | 2.79 ± 0.03 | 2.77 ± 0.02 | 2.75 ± 0.02 |
| Wine | 0.43 ± 0.86 | 0.93 ± 0.06 | 0.94 ± 0.12 | 0.93 ± 0.12 | 0.90 ± 0.09 | 0.81 ± 0.11 | 0.18 ± 0.39 |
| Yacht | 0.51 ± 0.37 | 1.55 ± 0.12 | 1.18 ± 0.21 | 0.94 ± 0.19 | 0.66 ± 0.18 | 0.51 ± 0.23 | 0.42 ± 0.22 |

### B.3. Hyperparameter Tuning for Financial Forecasting

The hyperparameters of the architecture, e.g., a number of LSTM layers, a number of fully connected layers, a number of LSTM hidden units, a number of hidden units in fully connected layers, an optimization procedure (weight decay and learning rate), and an uncertainty quantification associated parameters (dropout probability, and homoscedastic variance value for MCD and MultiSWAG) may be tuned for each of the approaches, e.g., using cross validation. It may be noted that all methods use the same feature extractor, LSTM and fully connected network, which is obtained by hyperparameter tuning each dataset to a single network. To hyperparameter tune, the full training period may be taken and split it into an ordered sequence of a 90% training period and a 10% validation period. The hyperparameters may be selected based on the combination that maximizes the NLL on the validation period for each dataset.

### C. Possible Extension to Classification Tasks.

Techniques like MDNs and DGMEs are not suited for dealing with classification tasks, since the output of both models is a mixture of Gaussian distributions. For classification tasks, a mixture of categorical distributions may be considered instead, rather than a mixture of Gaussian distributions. In particular, the conditional distribution pθ(y|x) is given by:

$${p}_{θ} ( y \vert x ) = {\sum }_{k = 1}^{K} {π}_{k} {\prod }_{i = 1}^{{d}_{v}} {{p}_{{θ}_{k}}^{i} ( x )}^{𝕀 ( y = i )} ,$$

In which p_{θ}_{ₖ}ⁱ(x) denotes the probability that y belongs to the i-th class according to the k-th mixture. In this case, it may be assumed that the MDNs and DGMEs output these probabilities rather than the mean and variance parameterizing a Gaussian distribution.

### C.1. Entropy Calculation.

To evaluate uncertainty in classification tasks, the average predictive entropy may be considered as the metric. To compute the average predictive entropy for a sample x, the following estimate may be used:

$$( x ) = - \frac{1}{M} {\sum }_{m = 1}^{M} {\sum }_{i ∈ C} {\tilde{p}}_{( m )}^{i} ( x ) log {\tilde{p}}_{( m )}^{i} ( x ) ,$$

where p₍ₘ₎⁻ⁱ(x) denotes the probability of class i according to the m-th sample from the predictive distribution and C denotes the set of classes. For both MDNs and DGMEs, these samples are obtained by the following procedure:

$${k}^{( m )} ∼ Categorical ( {π}_{1} , ... , {π}_{K} ) ,$$

$${\tilde{p}}_{( m )}^{i} = {p}_{{θ}_{k} ( m )}^{i} .$$

Note that the dropout may be incorporated in the training procedure of MDNs and DGMEs for this experiment by applying a stochastic forward pass to the sampled network k^{(m)}.

TABLE 11
Average predictive entropy for classification datasets. DGMEs
are able to appropriately reason about the underlying uncertainty of
OOD samples (MNIST with unknown classes and Fashion-MNIST) and
are competitive with respect to state-of-the-art approaches.
AVERAGE PREDICTIVE ENTROPY

| Dataset | MDNs | MCD | DEs | DGMEs |
|---|---|---|---|---|
| MNIST (Known) | 0.019 ± 0.005 | 0.012 ± 0.003 | 0.012 ± 0.002 | 0.015 ± 0.002 |
| MNIST (Unknown) | 0.192 ± 0.032 | 0.180 ± 0.020 | 0.180 ± 0.020 | 0.193 ± 0.016 |
| Fashion-MNIST | 0.663 ± 0.110 | 0.714 ± 0.140 | 0.706 ± 0.067 | 0.698 ± 0.057 |

### C.2. Example: Uncertainty Evaluation on MNIST.

As an example, the DGMEs ability to reason about the underlying uncertainty of new samples may be compared with the baseline approaches with regards to the MNIST handwritten digits dataset. Specifically, for each method, an MLP network may be trained with 3 hidden layers and 200 hidden units per layer with ReLU activations on the MNIST dataset, including only digits 0-3 and 5-9. After the models are trained, the average predictive entropy may be evaluated over three different datasets: the training dataset (known classes), a dataset containing only the digit 4 (unknown classes), and the Fashion-MNIST dataset (unrelated data). The value M=100 samples from the predictive distribution may be used to form an estimate of the predictive entropy for each method. How the average predictive entropy is computed for each method in the supporting material is described in more detail in Section B.3. The results for this experiment are shown in Table 11, which are averaged over 10 independent runs of each method. The results indicate that DGMEs are able to appropriately reason about the uncertainty in each of the datasets and are competitive with the baseline approaches in each case. DGMEs appropriately obtain that lowest entropy on the training dataset, e.g., the digits it was trained on, obtains a slightly higher entropy on the MNIST dataset containing unknown classes, and the highest entropy on the Fashion-MNIST dataset, which contains examples unrelated to the original classification task.

D. Sampling from the Predictive Distribution.

To understand how sampling from the predictive distribution works in DGMEs, the process may begin with standard formula for determining the predictive distributions in Bayesian models:

$$p ( y \vert x , 𝒟 ) = {\int }_{Θ} {p}_{θ} ( y \vert x ) p ( θ \vert 𝒟 ) d θ .$$

In the case of DGMEs, p_{θ}(y|x) is a mixture of Gaussian distributions and p(θ|D) is approximated via dropout. An important property of the predictive distribution in the case of mixture distributions is that it can be expressed as a mixture of predictive distributions. This property can be derived as follows:

$$\begin{matrix}p ( y \vert x , 𝒟 ) = {\int }_{Θ} {p}_{θ} ( y \vert x ) p ( θ \vert 𝒟 ) d θ \\ = {\int }_{Θ} ( {\sum }_{k = 1}^{K} {π}_{k} {p}_{k} ( y \vert x , {θ}_{k} ) ) p ( θ \vert 𝒟 ) d θ \\ = {\int }_{Θ} {\sum }_{k = 1}^{K} {π}_{k} {p}_{k} ( y \vert x , {θ}_{k} ) p ( θ \vert 𝒟 ) d θ \\ = {\sum }_{k = 1}^{K} {π}_{k} {\int }_{Θ} {p}_{k} ( y \vert x , {θ}_{k} ) p ( θ \vert 𝒟 ) d θ \\ = {\sum }_{k = 1}^{K} {π}_{k} {\int }_{{Θ}_{k}} {p}_{k} ( y \vert x , {θ}_{k} ) d {θ}_{k} {\underbrace{{\int }_{{Θ}_{- k}} p ( θ \vert 𝒟 ) d {θ}_{- k}}}_{p ( {θ}_{k} \vert 𝒟 )} \\ = {\sum }_{k = 1}^{K} {π}_{k} {\int }_{{Θ}_{k}} {p}_{k} ( y \vert x , {θ}_{k} ) p ( {θ}_{k} \vert 𝒟 ) d {θ}_{k}\end{matrix} .$$

Since pₖ(y|x, [symbol] )=∫_{Θ}_{ₖ}, pₖ(y|x, θₖ)p(θₖ| [symbol] )dθₖ, the following expression may be obtained for the predictive distribution:

$$p ( y \vert x , 𝒟 ) = {\sum }_{k = 1}^{K} {π}_{k} {p}_{k} ( y \vert x , {θ}_{k} ) .$$

This form implies that samples may be drawn from the predictive distribution in DGMEs using the following procedure:
(1) Sample the mixture component: k˜Categorical(π₁, . . . ,π_{K})
(2) Sample the posterior parameters of the given mixture component.
   In this work, dropout was used to approximate each posterior p(θₖ|D):

$${a}_{k , i} ∼ Bernoulli ( {p}_{d} ) , i = 1 , … , {d}_{θ} ,$$

$${θ}_{k} = {a}_{k} ⊙ {θ}_{k}^{★}$$

(3) Draw the sample of y from the appropriate predictive distribution:

$$y ∼ {p}_{k} ( y \vert x , {θ}_{k} )$$

### E. Comparison of Uncertainty Quantification Approaches.

Here, an overall comparison of the benchmarks used in the experiments of this work is provided as compared to the proposed approach along different qualities: the likelihood assumption, whether or not mixture weights are learned, how aleatoric uncertainty is quantified, and how epistemic uncertainty is quantified. This comparison is provided in Table 12.

TABLE 12
Summary of benchmarks as compared to DGMEs.

| | | | Aleatoric | | |
|---|---|---|---|---|---|
| Method | Likelihood | Mixture Weights | Uncertainty | Epistemic Uncertainty | Other Notes |
| MDNs | Mixture of | Learned and input | Heteroscedastic | None in original | Off-the-shelf can be applied to |
| | Gaussians | dependent | | implementation, but dropout | account for epistemic uncertainty |
| | | | | is applied for fair comparison | (e.g., dropout, Laplace |
| | | | | in this implementation | approximation, SWAG, |
| | | | | | variational Bayes, etc.) |
| MCD | Gaussian | Each prediction | Homoscedastic | Dropout | |
| | | made via a | | | |
| | | stochastic forward | | | |
| | | pass at test time is | | | |
| | | equally weighted. | | | |
| DEs | Gaussian | Assumed uniform | Heteroscedastic | Adversarial training and weight | |
| | | | | initialization. | |
| | | | | Dropout is also applied in this | |
| | | | | implementation using | |
| | | | | hyperparameter optimization. | |
| MultiSWAGGaussian | | Assumed uniform | Homoscedastic | Stochastic weight averaging | One can also account for |
| | | | | Gaussian (SWAG) | heteroscedasticity by applying |
| | | | | | SWAG training to a deep |
| | | | | | ensemble that outputs a mean |
| | | | | | and variance |
| DGMEs | Mixture of | Learned and | Heteroscedastic | Dropout in this implementation | Other methods to account for |
| | Gaussians | independent of input | | | epistemic can be used off-the- |
| | | | | | shelf (e.g., Laplace |
| | | | | | approximation, SWAG, |
| | | | | | variational Bayes, etc.) |

What is claimed is:

1. A method, comprising:
obtaining, by a processing system including a processor, a set of n training samples comprising a set of n features and a corresponding set of n output values associated with the set of features;
determining, by the processing system, a number, k, of mixture components;
obtaining, by the processing system, a set of k mixture weights and a set of k mixture parameters;
updating, by the processing system, a set of posterior probabilities according to the set of k mixture weights and the set of k mixture parameters for each k and n; and
updating, by the processing system, the set of mixture weights and the set of mixture parameters for each k according to an optimization process to obtain an updated set of k mixture weights and an updated set of k mixture parameters, wherein the updated set of k mixture weights are determined according to a sum of the set of posterior probabilities, and wherein the updated set of k mixture parameters are determined according to a stochastic optimization model.

2. The method of claim 1, wherein the obtaining the set of k mixture weights and the set of k mixture parameters further comprises:
initializing the set of mixture weights; and
initializing the set of k mixture parameters.

3. The method of claim 2, wherein the initializing the set of k mixture weights further comprises:
setting, by the processing system, each mixture weight of the set of k mixture weights to a value of 1/k.

4. The method of claim 2, wherein the initializing the set of k mixture parameters further comprises:
setting, by the processing system, each mixture parameter of the set of k mixture parameters to a common value determined according to a probability distribution of the mixing parameter.

5. The method of claim 1, further comprising:
repeating, by the processing system, the obtaining, the updating the posterior probabilities, and the updating the set of mixture weights and the set of mixture parameters, to obtain a further updated set of k mixture weights and a further updated set of k mixture parameters.

6. The method of claim 5, wherein the repeating is continued until a condition is satisfied.

7. The method of claim 6, further comprising:
determining, by the processing system, an incremental value for each repetition, wherein the condition comprises a number of repetitions corresponding to a predetermined number of iterations.

8. The method of claim 1, wherein the stochastic optimization model further comprises an argmax function.

9. The method of claim 1, wherein the stochastic optimization model further comprises:
minimizing, by the processing system, a weighted log likelihood of a conditional probability of updated set of k mixture parameters.

10. The method of claim 9, wherein the minimizing further comprises application of an ADAM optimizer algorithm.

11. A device, comprising:
a processing system including a processor; and
a memory that stores executable instructions that, when executed by the processing system, facilitate performance of operations, the operations comprising:
receiving a set of training samples comprising a set of features and a corresponding set of output values associated with the set of features;
identifying a number of mixture components;
obtaining a set of mixture weights and a set of mixture parameters;
revising a set of posterior probabilities according to the set of mixture weights and the set of mixture parameters; and
revising the set of mixture weights and the set of mixture parameters according to a process to obtain an updated set of mixture weights determined according to a sum of the set of posterior probabilities and an updated set of mixture parameters determined according to a numerical model.

12. The device of claim 11, wherein the operations further comprise:
repeating the obtaining, the revising the posterior probabilities, and the revising the set of mixture weights and the set of mixture parameters, to obtain a further revised set of mixture weights and a further revised set of mixture parameters.

13. The device of claim 12, wherein the operations further comprise:
generating a mixture ensemble according to the further revised set of mixture weights and the further revised set of mixture parameters.

14. The device of claim 13, wherein the mixture ensemble further comprises a mixture of gaussian distributions.

15. The device of claim 14, wherein mixture of gaussian distributions further comprises a linear combination of gaussian distributions determined according to the further revised set of mixture weights.

16. The device of claim 11, wherein mixture parameters of the set of mixture parameters correspond to weights and biases of a deep neural network trained according to the set of training samples.

17. A non-transitory, machine-readable medium, comprising executable instructions that, when executed by a processing system including a processor, facilitate performance of operations, the operations comprising:
identifying a number of mixture components of a mixture ensemble of an artificial neural network trained according to a set of features and a corresponding set of output values associated with the set of features;
determining a set of mixture weights and a set of mixture parameters of the mixture ensemble;
calculating a set of posterior probabilities according to the set of mixture weights and the set of mixture parameters; and
revising the set of mixture weights and the set of mixture parameters to obtain a revised set of mixture weights determined according to a sum of the set of posterior probabilities and a revised set of mixture parameters determined according to a numerical model.

18. The non-transitory, machine-readable medium of claim 17, wherein the operations further comprise:
repeating the determining, the calculating and the revising, to obtain a further revised set of mixture weights and a further revised set of mixture parameters.

19. The non-transitory, machine-readable medium of claim 18, wherein the operations further comprise:
generating the mixture ensemble according to the further revised set of mixture weights and the further revised set of mixture parameters.

20. The non-transitory, machine-readable medium of claim 19, wherein the mixture ensemble further comprises a mixture of gaussian distributions determined according to the further revised set of mixture weights.
